(19) United States
(12) Patent Application Publication
(10) Pub. No.: US 2025/0258513 A1
(43) Pub. Date: Aug. 14, 2025

(54) COOKING APPARATUS

(71) Applicant: SAMSUNG ELECTRONICS CO., LTD., Suwon-sI (KR)

(72) Inventors: Jonghoon LEE, Suwon-si (KR); Sangjin JEONG, Suwon-si (KR); Jihun HWANG, Suwon-si (KR)

(73) Assignee: SAMSUNG ELECTRONICS CO., LTD., Suwon-si (KR)

(21) Appl. No.: 19/193,264

(22) Filed: Apr. 29, 2025

Related U.S. Application Data
(63) Continuation of application No. PCT/KR2023/016381, filed on Oct. 20, 2023.

(30) Foreign Application Priority Data
Nov. 21, 2022 (KR) 10-2022-0156769
Jan. 6, 2023 (KR) 10-2023-0002454

(51) Int. Cl. G05G 1/08; F24C 15/00; G05G 5/00

(52) U.S. Cl. CPC G05G 1/082; F24C 15/00; G05G 5/005; G05G 2505/00

(57) ABSTRACT

A cooking apparatus including a heating source; a housing comprising a control panel; a regulator body; a shaft moveable between a first shaft position, in which a rotation of the shaft with respect to the regulator body is restricted, or to a second shaft position, in which the rotation of the shaft with respect to the regulator body for operating the heating source in unrestricted; a knob moveable with the shaft; a locking device to be moveable relative to the knob, the locking device comprising a locker moveable between a locking position, in which the locker is positioned between the knob and the control panel to restrict the movement of the knob while the shaft is in the first shaft position or to an unlocking position, in which the locker is at least partially received in a locker accommodation space to allow movement of the knob.

### CROSS-REFERENCE TO RELATED APPLICATION

This application is a continuation application is a continuation application, under 35 U.S.C. § 111 (a), of international application No. PCT/KR2023/016381, filed Oct. 20, 2023, which claims priority under 35 U. S. C. § 119 to Korean Patent Application No. 10-2022-0156769, filed Nov. 21, 2022 and Korean Patent Application No. 10-2023-0002454, filed Jan. 6, 2023, the disclosures of which are incorporated herein by reference in their entireties.

### TECHNICAL FIELD

The present disclosure relates to a cooking apparatus. More particularly, the present disclosure relates to a cooking apparatus including a knob assembly.

### BACKGROUND ART

In general, a cooking apparatus is an appliance that cooks food by including a cooking chamber, a heating device configured to apply heat to the cooking chamber, and a circulation device configured to circulate the heat generated by the heating device within the cooking chamber. The cooking apparatus is a device that cooks food by sealing and heating the food, and may generally be classified into electric, gas, and electronic types depending on the heating source of the heating device. For example, an electric oven may use heat of a heater driven by electricity as a heating source, a gas oven may use heat of gas as a heating source, and a microwave oven may use frictional heat of water molecules caused by high frequency as a heating source.

The cooking apparatus may be provided with a control panel on either a front or upper surface of a main body. The control panel may be provided with a number of buttons, keypads, and/or knob assemblies configured to allow a user to set a desired cooking mode or set various conditions necessary for cooking.

A control device configured to control a heating device may be operated in a push and turn manner. A knob assembly provided to operate the control device may control the operation of the cooking apparatus by a two-step mechanism in which a control shaft of the control device is pressed and then turned.

Meanwhile, if a user operates the knob assembly unintentionally, it may cause fire and/or burns.

### DISCLOSURE

### Technical Problem

The present disclosure is directed to providing a knob assembly capable of preventing malfunction, and a cooking apparatus including the same.

Further, the present disclosure is directed to providing a knob assembly capable of preventing malfunction in a pushing operation, and a cooking apparatus including the same.

Further, the present disclosure is directed to providing a cooking apparatus including a regulator device configured not to operate unless an additional action of pressing a button is performed.

Further, the present disclosure is directed to providing a cooking apparatus including a movable locker configured to restrict movement of a knob assembly based on a button being pressed.

Further, the present disclosure is directed to providing a cooking apparatus capable of guiding movement of a button to allow a position of a locker to change by precise movement of the button.

Further, the present disclosure is directed to providing a cooking apparatus capable of preventing a locker from scratching a control panel while the locker restricts movement of a knob assembly

Additional aspects of the disclosure will be set forth in part in the description which follows and, in part, will be obvious from the description, or may be learned by practice of the disclosure.

### Technical Solution

One aspect of the present disclosure provides a cooking apparatus including: a heating source; a housing including a control panel; a regulator body configured to operate the heating source and be disposed adjacent to the control panel; a shaft to be coupled to the regulator body to move between a first shaft position, in which a rotation of the shaft with respect to the regulator body is restricted, and a second shaft position, in which the rotation of the shaft with respect to the regulator body for operating the heating source is unrestricted; and a knob coupled to the shaft so as to move along with the shaft. The cooking apparatus includes a locking device including a locker moveable relative to the knob whereby locker is configured to move between a locking position, in which the locker is positioned between the knob and the control panel to restrict a movement of the knob while the shaft is at the first shaft position, and an unlocking position, in which the locker is at least partially received in a locker receiving space to allow the movement of the knob.

The cooking apparatus may further include a button configured to move between a first button position that restricts movement of the locker from the locking position to the unlocking position, and a second button position that allows the movement of the locker from the locking position to the unlocking position. The locker receiving space may be disposed on the button.

The locker may extend along a direction facing the control panel.

The button may include a locker contact surface adjacent to an opening of the locker receiving space. The locker may be disposed at the locking position in which the locker comes into contact with the locker contact surface while the button is at the first button position, and the locker may be movable to the unlocking position in which the locker is received in the locker receiving space while the button is at the second button position.

The cooking apparatus may further include a button holder received in the knob and including a locking device mounting space. The button may be received in the locking device mounting space, the button may be disposed adjacent to one surface of the button holder while the button is at the first button position and the button may move closer to the other surface facing the one surface of the button holder while the button moves from the first button position to the second button position.

The button holder may include a guide hook portion disposed adjacent to the button and protruding toward the control panel to guide movement of the button.

The cooking apparatus may include a button elastic member disposed between the knob and the button holder to allow the button to be pressed from the second button position to the first button position.

The button elastic member may include a first button elastic member and a second button elastic member different from the first button elastic member to allow the button to move linearly.

The regulator body may further include a case including a stopper groove. The shaft may include a shaft body at least partially inserted into the case, and a stopper protruding from the shaft body to be received in the stopper groove while the shaft is at the first shaft position, the stopper detached from the stopper groove while the shaft is at the second shaft position.

A distance by which the locker moves from the locking position to the unlocking position may be greater than or equal to a distance by which the shaft moves from the first shaft position to the second shaft position.

A direction, along which the button moves from the first button position to the second button position, may intersect a direction, along which the locker moves from the locking position to the unlocking position.

The cooking apparatus may further include a locker supporter mounted on the control panel and provided to come into contact with the locker to prevent the control panel from being scratched by the locker.

The locker may be disposed adjacent to the shaft to prevent vibration of the knob.

The cooking apparatus may further include a weight disposed on an opening of the knob, the weight including a locker hole through which the locker penetrates to allow the locker to be exposed to an outside of the weight.

The weight may include a button movement limiter protruding to an opposite direction facing the control panel to be in contact with the button in response to the button being at the second button position, so as to guide movement of the button to the second button position.

Another aspect of the present disclosure provides a cooking apparatus including: a housing including a control panel; a regulator device including a regulator body and a shaft provided to penetrate the control panel, the shaft configured to move to a first shaft position, in which rotation with respect to the regulator body is restricted, and a second shaft position, which allows rotation with respect to the regulator body; and a knob assembly coupled to the shaft to move along with the shaft. The knob assembly includes a locking device including a locker configured to move to a locking position, in which the locker is positioned between the knob and the control panel to restrict the movement of the knob while the shaft is at the first shaft position, and an unlocking position, in which the locker is at least partially received in a locker receiving space to allow the movement of the knob. The knob assembly further includes a button disposed in the locker receiving space, and configured to move to a first button position that restricts movement of the locker from the locking position to the unlocking position, and a second button position that allows the movement of the locker from the locking position to the unlocking position.

The locker may extend from the button to a direction facing the control panel.

The button may include a locker contact surface adjacent to an opening of the locker receiving space. The locker may be disposed at the locking position in which the locker comes into contact with the locker contact surface while the button is at the first button position, and the locker may be movable to the unlocking position in which the locker is received in the locker receiving space while the button is at the second button position.

The cooking apparatus may further include a button holder received in the knob and including a locking device mounting space. The button may be received in the locking device mounting space, the button may be disposed adjacent to one surface of the button holder while the button is at the first button position, and the button may move closer to the other surface facing the one surface of the button holder while the button moves from the first button position to the second button position.

Another aspect of the present disclosure provides a cooking apparatus including a control panel; a regulator body disposed to face one side of the control panel; a shaft at least partially inserted into the regulator body; and a knob assembly disposed on the other side of the control panel and coupled to the shaft. The knob assembly includes a locking device including a locker configured to move to a locking position that restricts movement of the knob, and an unlocking position, in which the locker is at least partially received in a locker receiving space to allow the movement of the knob.

### Advantageous Effects

A cooking apparatus may include a regulator device operated by a push and turn method, and a knob assembly coupled thereto. Further, the knob assembly may include a locker for preventing pushing of the knob assembly and thus malfunction may be prevented.

Further, a cooking apparatus may include a locker protruding from a knob assembly toward a control panel, and thus as the locker is contacted, malfunction in a pushing operation may be prevented.

Further, as for a cooking apparatus, based on a button being pressed, a locker may be moved to an inside of a knob assembly so as to allow a pushing operation of the knob assembly. Accordingly, a regulator device may not operate unless an additional operation of pressing a button is performed.

Further, as for a cooking apparatus, based on a button being pressed, a locker receiving space provided to receive at least a portion of a locker may be aligned with the locker, and thus the locker configured to restrict movement of a knob assembly may be movable.

Further, as for a cooking apparatus, a locker receiving space may be positioned in a button, and movement of the button may be guided by a guide hook portion. Accordingly, the movement of the button may be guided to allow a position of the locker to change according to the movement of the button.

Further, a cooking apparatus may include a locker supporter provided to be in contact with a locker, and thus it is possible to prevent the locker from scratching a control panel.

### DESCRIPTION OF DRAWINGS

FIG. 1 is a perspective view of a cooking apparatus according to one embodiment of the present disclosure.

FIG. 2 is a front view of the cooking apparatus illustrated in FIG. 1 according to an embodiment of the present disclosure.

FIG. 3 is a cross-sectional view taken along line II-II′ of the cooking apparatus illustrated in FIG. 1 according to an embodiment of the present disclosure.

FIG. 4 is an enlarged view illustrating a portion of the cooking apparatus illustrated in FIG. 1 where a knob assembly is arranged according to an embodiment of the present disclosure.

FIG. 5 is a perspective view illustrating a regulator device illustrated in FIG. 4 according to an embodiment of the present disclosure.

FIG. 6 is an exploded perspective view of the regulator device illustrated in FIG. 5 according to an embodiment of the present disclosure.

FIG. 7 is a cross-sectional view taken along line VII-VII′ of the regulator device illustrated in FIG. 5 according to an embodiment of the present disclosure.

FIG. 8 is a rear perspective view illustrating a shaft inserted into an outer cover of the regulator device illustrated in FIG. 6 according to an embodiment of the present disclosure.

FIG. 9 is a perspective view of the knob assembly illustrated in FIG. 4 according to an embodiment of the present disclosure.

FIG. 10 is an exploded view of the knob assembly illustrated in FIG. 9 according to an embodiment of the present disclosure.

FIG. 11 is a cross-sectional perspective view illustrating a state in which the regulator device illustrated in FIG. 4 is mounted on a control panel according to an embodiment of the present disclosure.

FIG. 12 is a perspective view illustrating a state before a locker supporter is inserted into the control panel illustrated in FIG. 11 according to an embodiment of the present disclosure.

FIG. 13 is a perspective view illustrating a state after the locker supporter is inserted into the control panel illustrated in FIG. 12 according to an embodiment of the present disclosure.

FIG. 14 is a cross-sectional view mainly illustrating the knob assembly and the regulator device of the cooking apparatus illustrated in FIG. 3 according to an embodiment of the present disclosure.

FIG. 15 is a cross-sectional view mainly illustrating the knob assembly illustrated in FIG. 14 according to an embodiment of the present disclosure.

FIG. 16 is a cross-sectional view illustrating a state in which a button is pressed in the knob assembly illustrated in FIG. 15 according to an embodiment of the present disclosure.

FIG. 17 is a perspective view illustrating a locker of the knob assembly illustrated in FIG. 15 and a configuration related thereto according to an embodiment of the present disclosure.

FIG. 18 is a front view illustrating the button inserted into a button holder illustrated in FIG. 17 according to an embodiment of the present disclosure.

FIG. 19 is an enlarged perspective view illustrating a state before the locker is inserted into a locker receiving space in the configuration related to the locker illustrated in FIG. 17 according to an embodiment of the present disclosure.

FIG. 20 is an enlarged perspective view illustrating a state after the locker is inserted into the locker receiving space in the configuration related to the locker illustrated in FIG. 18 according to an embodiment of the present disclosure.

FIG. 21 is a perspective view illustrating a state in which the button holder and a configuration related thereto illustrated in FIG. 17 is inserted into the knob according to an embodiment of the present disclosure.

FIG. 22 is a perspective view illustrating a weight illustrated in FIG. 10 according to an embodiment of the present disclosure.

FIG. 23 is a perspective view illustrating the button illustrated in FIG. 10 according to an embodiment of the present disclosure.

FIG. 24 is a cross-sectional view of a knob assembly and a configuration related thereto according to one embodiment of the present disclosure.

FIG. 25 is a cross-sectional view of a knob assembly and a configuration related thereto according to one embodiment of the present disclosure.

FIG. 26 is a cross-sectional view of a knob assembly and a configuration related thereto according to one embodiment of the present disclosure.

FIG. 27 is a cross-sectional view of a knob assembly and a configuration related thereto according to one embodiment of the present disclosure.

FIG. 28 is a cross-sectional view of a knob assembly and a configuration related thereto according to one embodiment of the present disclosure.

FIG. 29 is a cross-sectional view illustrating a state in which a button of the knob assembly illustrated in FIG. 28 is pressed according to an embodiment of the present disclosure.

FIG. 30 is a perspective view illustrating the button, a locker and a shaft before the locker illustrated in FIG. 28 is accommodated in a locker insertion space according to an embodiment of the present disclosure.

FIG. 31 is a cross-sectional view of a knob assembly and a configuration related thereto according to one embodiment of the present disclosure.

FIG. 32 is a cross-sectional view of a knob assembly and a configuration related thereto according to one embodiment of the present disclosure.

### MODES OF THE INVENTION

The various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of “and/or” includes a plurality of combinations of relevant items or any one item among a plurality of relevant items.

Herein, the expressions “a first”, “a second”, “the first”, “the second”, etc., may simply be used to distinguish an element from other elements, but is not limited to another aspect (importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third element.

In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

In the following detailed description, the terms of “up and down direction”, “lower side”, “front and rear direction” and the like may be defined by the drawings, but the shape and the location of the element is not limited by the term

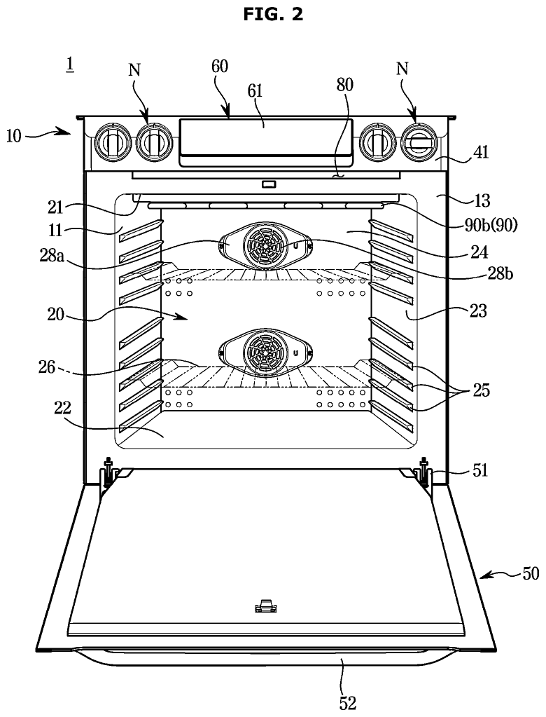

Particularly, as shown in FIG. 2, a direction in which a cooking chamber of a cooking apparatus 1 is opened is defined as the front, and the rear, left and right sides, and upper and lower sides are defined based on the front side.

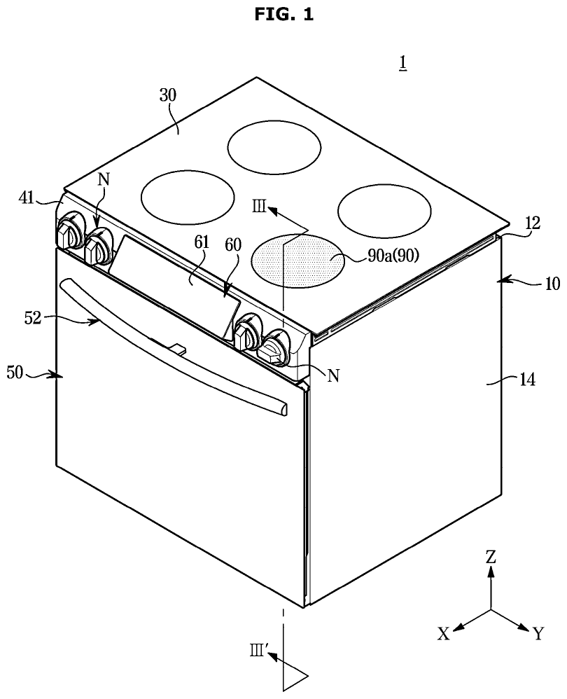

Particularly, for the X, Y, and Z directions shown in FIG. 1, the +X direction is defined as the front side, the +Y direction is defined as the left side, and the +Z direction is defined as the upper side, and the directions are defined based on these.

Hereinafter exemplary embodiments of the present disclosure will be described in detail with reference to the accompanying drawings.

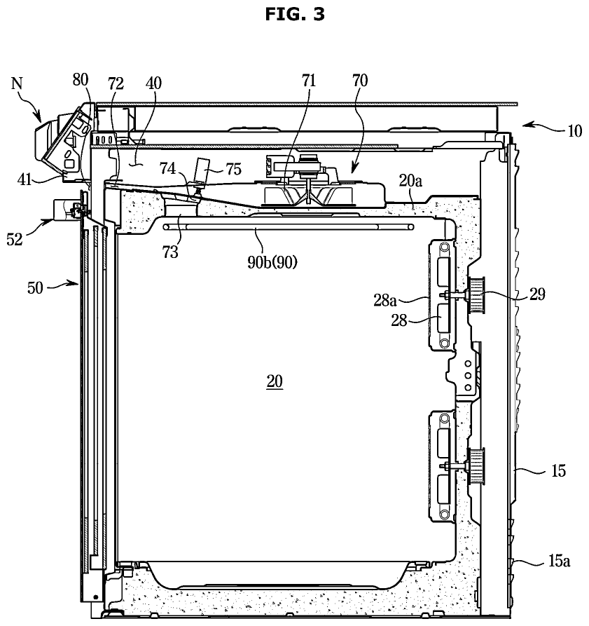

FIG. 1 is a perspective view of the cooking apparatus 1 according to one embodiment of the present disclosure. FIG. 2 is a front view of the cooking apparatus 1 illustrated in FIG. 1. FIG. 3 is a cross-sectional view taken along line II-III′ of the cooking apparatus 1 illustrated in FIG. 1.

An inner housing 11 and an outer housing 12 may each have a substantially box shape with an open front surface.

The cooking apparatus 1 may include a cook top 30 disposed on an upper end of the cooking apparatus 1, and the cook top 30, on which a container containing food is disposed, may heat the container. The cooktop 30 may be provided with at least one heating portion 90a. A container containing food may be placed in the heating portion 90a and heated directly.

The cooking apparatus 1 may include a door 50 disposed on a front surface of a housing 10 to open and close the cooking chamber 20.

The outer housing 12 may include a front panel 13 forming the front surface of the housing 10, a side panel 14 forming a side surface of a main body, and a rear panel 15 forming a rear surface of the housing 10.

An opening may be provided in the front panel 13, and a front surface of the cooking chamber 20 provided inside the housing 10 may be opened by the opening. The outer housing 12 may include a control panel 41 disposed in an upper portion of the front panel 13 and provided to cover an electric component chamber 40. A display module 60 may be mounted on the control panel 41.

The control panel 41 may be disposed on at least a portion of the housing 10. According to one embodiment of the present disclosure, the control panel 41 may be disposed on a portion of the front surface of the housing 10. However, the present disclosure is not limited thereto, and the control panel 41 may be disposed on the upper surface of the housing 10 or may form one surface of the housing 10.

Alternatively, the housing 10 may include the control panel 41.

The rear panel 15 may be provided with an inlet 15a to allow air to be drawn into the electric component chamber 40. The air drawn into the electric component chamber 40 through the inlet 15a may flow inside the electric component chamber 40 and may cool electric components. However, the position of the inlet 15a is not limited thereto, and may be disposed in any position that draws in outside air and guides the outside air to the electric component chamber 40.

The cooking chamber 20 may be formed by an upper plate 21, a bottom plate 22, both side plates 23, and a rear plate 24. The cooking chamber 20 is a cooking space in which a front surface is open through an opening in the front panel 13 to allow food to be placed in and out.

A plurality of supports 25 may be provided on inner surfaces of the both side plates 23. At least one detachable rack 26 on which food may be placed may be mounted on the plurality of supports 25.

A rail (not shown) may be installed on the plurality of supports 25 to allow a rack 26 to slide. A user can take out or place food by moving the rack 26 through the rail (not shown).

A divider (not shown) provided to divide the cooking chamber 20 into a plurality of spaces may be removably mounted on the plurality of supports 25. The cooking chamber 20 divided into the plurality of spaces by the divider may not have the same size, and each size may be different from each other.

Accordingly, a user can utilize the space of the cooking chamber 20, which is divided into the plurality of spaces, in various ways according to the user intention. The divider may be formed of an insulating material and may insulate each cooking chamber 20.

A heater 90b configured to heat food may be provided in the cooking chamber 20. The heater 90b may be an electric heater including an electric resistor. However, the heater 90b is not limited thereto and may be a gas heater configured to generate heat by burning gas. That is, the cooking apparatus 1 may include an electric oven and a gas oven.

The cooking apparatus 1 may include a heating source 90. The heating source 90 may be configured to heat food.

The heating source 90 may include the above-mentioned heating portion 90a and heater 90b.

The rear plate 24 of the cooking chamber 20 may be provided with a circulation fan 28 configured to circulate air in the cooking chamber 20 to heat the food evenly, and a circulation motor 29 configured to drive the circulation fan 28.

A fan cover 28a may be provided on a front surface of the circulation fan 28 to cover the circulation fan 28, and an outlet hole 28b through which air flows may be formed in the fan cover 28a.

The open front surface of the cooking chamber 20 may be opened and closed by the door 50, and the door 50 may be coupled to the housing 10 by a hinge 51, which is disposed in a lower portion of the housing 10, so as to be rotatable with respect to the housing 10.

A handle 52 may be provided in a front upper portion of the door 50 to be held by a user so as to allow the door 50 to open and close the cooking chamber 20.

The display module 60 provided to display various operation information of the cooking apparatus 1 and to allow a user to input operation commands may be mounted on the control panel 41 provided on the front upper portion of the front panel 13.

The display module 60 may include a liquid crystal display (LCD) device, and the liquid crystal display device may display electrical information about changes in liquid crystal transmittance according to the applied voltage as visual information. The liquid crystal display device may include a liquid crystal module configured to display an image, and a light source unit configured to emit light to the liquid crystal module. A light emitting diode (LED) may be used as the light source unit.

The display module 60 may include a cover panel 61 provided on a front surface of the liquid crystal display device. The cover panel 61 may simply be a protection panel to protect the liquid crystal display device, but may also be a touch panel configured to receive a user's touch command.

The control panel 41 may be provided with a knob assembly N configured to operate the cooking apparatus 1. According to one embodiment of the present disclosure, four knob assemblies N may be provided. However, the present disclosure is not limited thereto. A detailed description of the knob assembly N is provided below.

An insulating material 20a may be disposed between the electric component chamber 40 and the cooking chamber 20 to insulate the electric component chamber 40 and the cooking chamber 20 so as to prevent heat of the cooking chamber 20 from being transmitted to the electric component chamber 40.

The insulating material 20a may cover not only a space between the electric component chamber 40 and the cooking chamber 20 but also the entire outside of the cooking chamber 20 to prevent heat of the cooking chamber 20 from being transferred to the outside of the cooking apparatus 1.

Because a temperature inside the electric component chamber 40 rises due to the heat of various electric components, the cooking apparatus 1 may be provided with a blowing device 70 configured to cool the electric component chamber 40 by circulating air around the electric component chamber 40.

The blowing device 70 may include a blower fan 71 configured to move air, and a discharge flow path 72 provided to discharge the air drawn by the blower fan 71 to the front side of the cooking apparatus 1.

The blower fan 71 may draw air in an axial direction and then discharge the drawn air in a radial direction. That is, the blower fan 71 according to the present disclosure may be a centrifugal fan. Alternatively, the blower fan 71 may include an axial fan.

The outside air may be drawn into the electric component chamber 40 through the inlet 15a formed in the rear panel 15, and the air drawn into the electric component chamber 40 may cool the electric components while moving inside the electric component chamber 40. The air may be discharged to the front side of the cooking apparatus 1 through an outlet 80 along the discharge flow path 72.

The outlet 80 may include a space between the front panel 13 and the control panel 41. However, the present disclosure is not limited thereto, and the outlet 80 may be provided in various positions and have various shapes as long as the air drawn through the inlet 15a may be discharged to the outside of the main body 1.

A portion of the air inside the cooking chamber 20 may be drawn into the discharge flow path 72 through a cooking chamber flow path 73 and discharged to the front surface of the cooking apparatus 1.

A bypass hole 74 may be formed in the discharge flow path 72 to allow a portion of air, which flows from the discharge flow path 72 to the outlet 80, to flow into the cooking chamber flow path 73. The bypass hole 74 may be opened and closed by an opening and closing device 75.

As the bypass hole 74 is opened or closed by the opening and closing device 75, an amount of air, which moves from the discharge flow path 72 to the outlet 80 and flows in the cooking chamber flow path 73, may be regulated. Accordingly, it is possible to regulate an amount of air discharged from the cooking chamber 20 to the cooking chamber flow path 73.

The door 50 rotatably coupled to the front surface of the housing 10 to open and close the cooking chamber 20 may include a plurality of glasses. A space may be formed between the plurality of glasses, and as outside air is provided to flow into and circulate in the space, the door 50 may dissipate heat.

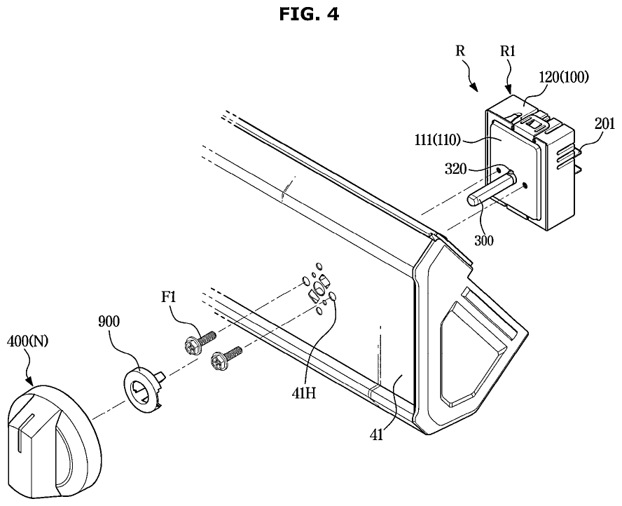

FIG. 4 is an enlarged view illustrating a portion of the cooking apparatus 1 illustrated in FIG. 1 where the knob assembly N is arranged.

The cooking apparatus 1 may include the knob assembly N. The knob assembly N may be configured to receive a user input to control the heating source 90 of the cooking apparatus 1.

The cooking apparatus 1 may include the housing 10 including the control panel 41.

The knob assembly N may be coupled to the control panel 41.

The knob assembly N may include a knob 400 located on one side of the control panel 41. The knob 400 may be provided to be held by a user and to allow the user to input a user input.

The knob 400 may be located on the front side of the control panel 41. Accordingly, the knob 400 may be exposed to a user.

The knob 400 may be rotatable relative to the control panel 41. The knob 400 may rotate with respect to an axis. A user can input a user input by rotating the knob 400.

The knob 400 may have a portion having a substantially cylindrical shape. The cylindrical portion of the knob 400 may be accommodated in the control panel 41. Accordingly, the knob 400 may be configured to be rotatable.

The knob 400 may include a portion extending in one direction and protruding forward to be easily held by a user. A user can rotate the knob 400 by holding a portion of the knob 400 that extends in one direction and protrudes forward.

The knob 400 may include a plastic material. However, the present disclosure is not limited thereto.

The knob 400 may be formed through an injection process. However, the present disclosure is not limited thereto.

The knob 400 may include a shaft mounting hole 400H. The shaft mounting hole 400H may be a hole into which a shaft 200 of a regulator device R, which will be described later, is inserted.

The shaft mounting hole 400H may extend along a rotation axis of the knob 400.

The knob 400 may be coupled to the shaft 300 so as to be movable together with the shaft 300.

The knob assembly N may include the regulator device R. The regulator device R may be configured to generate a signal in response to a user input transmitted through the knob 400.

The cooking apparatus 1 may include a locker supporter 900.

The locker supporter 900 may be disposed between the knob assembly N and the control panel 41.

The locker supporter 900 may prevent scratches from forming on the control panel 41.

This will be described later along with related drawings.

The regulator device R may detect a user input to operate the heating source 90.

The regulator device R may be coupled to the knob 400. At least a portion of the regulator device R may be located behind the control panel 41. Accordingly, the regulator device R may be prevented from being exposed to a user.

The regulator device R may include a case 100. The case 100 may be a component that defines at least portion of an exterior of the regulator device R.

The case 100 may have a substantially rectangular parallelepiped shape.

The regulator device R may include a regulator body R1. The regulator body R1 may be a rest configuration of the regulator device R except the shaft 300 described later.

The regulator body R1 may be fitted with at least a portion of the shaft 300.

The regulator body R1 may have a substantially rectangular parallelepiped shape. However, the present disclosure is not limited thereto.

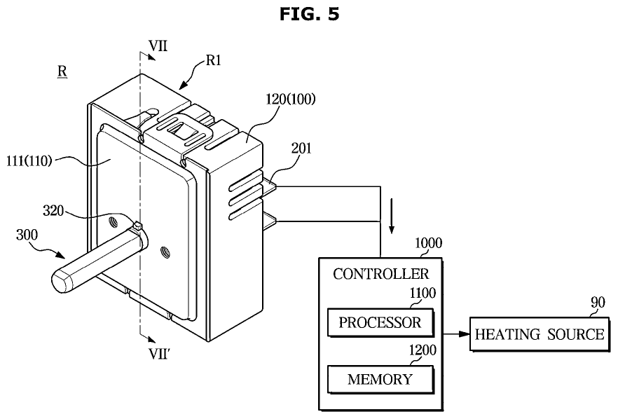

The regulator body R1 may transmit a signal to a processor (FIG. 5) by the flow of electricity. The processor may generate a signal to operate the heating source 90 by the signal generated by the regulator body R1.

The regulator body R1 may be located adjacent to the control panel 41. The regulator body R1 may be positioned between the knob assembly N and the control panel 41.

The regulator body R1 may operate the heating source 90 and be positioned adjacent to the control panel 41.

The regulator body R1 may be positioned to face one side of the control panel 41.

The knob assembly N may be located on the other side of the control panel 41 and coupled to the shaft 300.

The regulator device R may include the shaft 200. The shaft 200 may be rotatably inserted into the case 100.

The shaft 200 may be coupled to the knob 400. The shaft 200 may rotate along with the rotation of the knob 400. The shaft 200 may be inserted into the shaft mounting hole 400H. Accordingly, a user can rotate the knob 400, and the rotation of the knob 400 may be transmitted to the shaft 200. As the shaft 200 rotates together, the regulator may generate a signal.

The shaft 200 may extend along the rotation axis of the knob 400.

The shaft 200 may be positioned by penetrating the control panel 41. A portion of the shaft 200 that is located in the front by penetrating the control panel 41 may be coupled to the knob 400. A portion of the shaft 200 located behind the control panel 41 may be coupled to the case 100.

The shaft 300 may be at a first shaft position in which rotation relative to the regulator body R1 is limited. The shaft 300 may be coupled to the regulator body R1 so as to be movable to a second shaft position in which the shaft 300 is rotatable with respect to the regulator body R1 to operate the heating source 90.

The shaft 200 may include a body of the shaft 200. The body of the shaft 200 may be a component that defines at least portion of an exterior of the shaft 200.

The body of the shaft 200 may include a knob mounting portion 211. The knob mounting portion 211 may be a component coupled to the knob 400.

The knob mounting portion 211 may be a component that is not rotationally symmetrical. The knob mounting portion 211 may be accommodated in the shaft mounting hole 400H. The shaft mounting hole 400H may have a shape corresponding to the knob mounting portion 211. Accordingly, the knob mounting portion 211 may rotate along with the rotation of the knob 400.

The case 100 may include a regulator screw hole 101H. The screw hole may be a hole into which a screw is mounted.

The control panel 41 may include a panel screw hole 41H. The panel screw hole 41H may be a hole provided at a position corresponding to the regulator screw hole 101H.

A fastening member may couple the control panel 41 and the regulator device R by penetrating the panel screw hole 41H and the regulator screw hole 101H.

Hereinafter the regulator device R will be described in more detail.

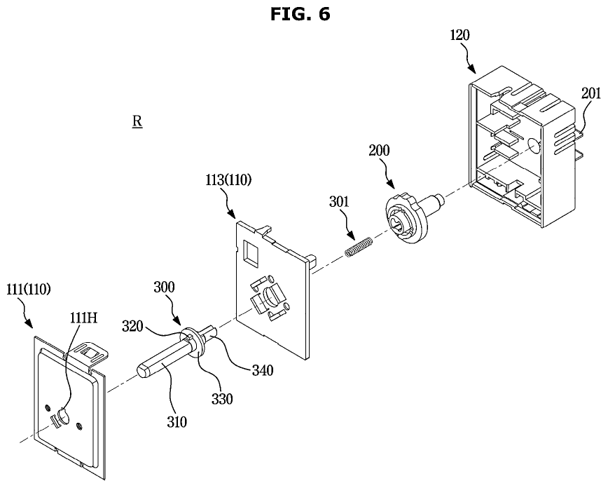

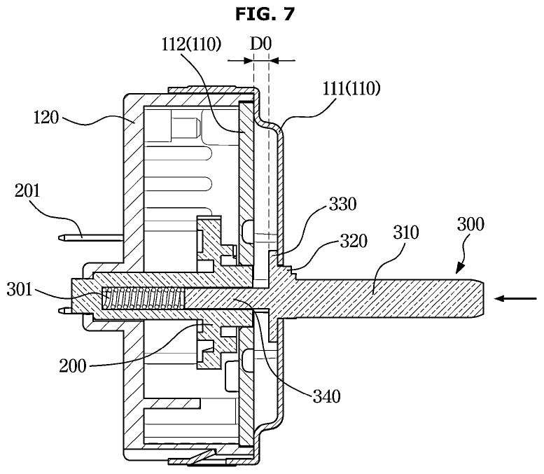

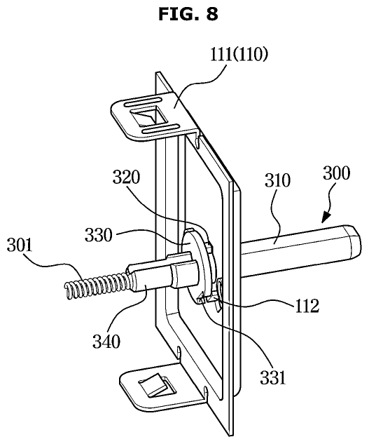

FIG. 5 is a perspective view illustrating the regulator device R illustrated in FIG. 4. FIG. 6 is an exploded perspective view of the regulator device R illustrated in FIG. 5. FIG. 7 is a cross-sectional view taken along line VII-VII′ of the regulator device R illustrated in FIG. 5. FIG. 8 is a rear perspective view illustrating the shaft 300 inserted into an outer cover 111 of the regulator device R illustrated in FIG. 6.

The regulator device R according to one embodiment of the present disclosure will be described with reference to FIGS. 5 to 8.

The cooking apparatus 1 may include a controller 1000.

The controller 1000 may include a processor 1100 and a memory 1200.

The processor 1100 may include a program (a plurality of instructions) for processing signals and providing control signals.

The memory 1200 may include a volatile memory such as Static Random Access Memory (S-RAM) and Dynamic Random Access Memory (D-RAM), and a non-volatile memory such as Read Only Memory (ROM), and Erasable Programmable Read Only Memory (EPROM).

The memory 1200 may be provided integrally with the processor 1100 or may be provided as a semiconductor device separate from the processor 1100.

The processor 1100 may further include a processing core (e.g., a memory circuit and a control circuit) configured to process signals based on the program or data stored in the memory 1200 and configured to output a control signal.

When a first terminal (not shown) and a second terminal (not shown) are in contact, the regulator device R may generate a signal for the processor 1100 to receive.

The processor 1100 may control the heating source 90 to allow the heating source 90 to operate based on a user input detected by the regulator device R.

The processor 1100 may control the heating source 90 to operate the heating source 90 based on a signal generated in response to a user input from the regulator device R.

However, in order to allow the cam 200 to rotate through the rotation of the shaft 300, the shaft 300 may need to be at the second shaft position.

This is because when the shaft 300 is at the first shaft position, a stopper 320 (FIG. 5) is received in a stopper groove 111H (FIG. 5), thereby limiting rotation of the shaft 300.

Accordingly, the regulator device R may be operated only when the shaft 300 is moved from the first shaft position to the second shaft position.

The cooking apparatus 1 may include the regulator device R.

The regulator device R may include the regulator body R1. The regulator body R1 may include the case 100. The regulator body R1 may include the cam 200. The regulator body R1 may include a terminal 201.

The regulator device R may include the case 100.

The case 100 may include a case body 120. The case body 120 may be a component that defines at least a portion of an exterior of the case 100.

When the case 100 has the shape of a rectangular parallelepiped, the case body 120 may be a component that defines five surfaces of the rectangular parallelepiped.

The case body 120 may have an operating space formed therein. The operating space may be a space surrounded by the five surfaces of the case body 120. The operating space may include an opening.

The opening of the operating space may be positioned towards the front.

A configuration described later may be accommodated inside the case 100 through the opening of the operating space.

The case body 120 may be formed of plastic. However, the present disclosure is not limited thereto.

The case body 120 may be formed by injection molding. However, the present disclosure is not limited thereto.

The case 100 may include a case cover 110. The case cover 110 may be configured to close the opening of the operating space.

The case cover 110 may be positioned adjacent to the case body 120. The case cover 110 may be configured to close the operating space defined by the case body 120.

The case cover 110 may include an inner cover 113.

When the case 100 has a rectangular parallelepiped shape, the inner cover 113 may define one surface in addition to the five surfaces defined by the case body 120.

The inner cover 113 may be located in front of the case body 120.

The inner cover 113 may have the shape of a flat plate with a predetermined thickness. However, the present disclosure is not limited thereto.

The inner cover 113 may be formed of plastic. However, the present disclosure is not limited thereto.

The inner cover 113 may be formed by injection molding. However, the present disclosure is not limited thereto.

The case cover 110 may include the outer cover 111. The outer cover 111 may be a component located outside the case 100 than the inner cover 113.

The outer cover 111 may cover the inner cover 113. The outer cover 111 may be provided to correspond to the inner cover 113.

The outer cover 111 may be located in front of the inner cover 113.

The outer cover 111 may have the shape of a flat plate with a predetermined thickness. However, the present disclosure is not limited thereto.

The outer cover 111 may be formed of a metal material. The outer cover 111 may have greater rigidity than the case body 120. However, the present disclosure is not limited thereto.

The outer cover 111 may be formed through a press process. However, the present disclosure is not limited thereto.

The outer cover 111 may include a shaft hole 710H. The shaft 300 may pass through the shaft hole 710H.

The shaft hole 710H may have a shape that allows the shaft 300 to pass therethrough. For example, when the shaft 300 has a circular cross-section, the shaft hole 710H may also be provided to have a cylindrical shape.

The shaft hole 710H may have a shape corresponding to the cross-sectional shape of the shaft 300. For example, the shaft hole 710H may have the shape of a cylinder with a diameter similar to the cross-sectional shape of the shaft 300. The similar diameter may mean that the shaft hole 710H has a tolerance in the cross-sectional shape of the shaft 300 to allow the shaft 300 to move through the shaft hole 710H.

The shaft hole 710H may be located at the center of gravity of the case cover 110. That is, when the case cover 110 has a substantially rectangular shape, the shaft hole 710H may be located at a position corresponding to the center of the diagonal line.

The outer cover 111 may include the stopper groove 111H. The case 100 may include the stopper groove 111H. The stopper groove 111H may be a groove into which the stopper 320 of the shaft 300, which will be described later, is inserted.

The stopper groove 111H may be located in the case cover 110.

The case 100 may include the stopper groove 111H.

The stopper groove 111H may extend from the shaft hole 710H. The stopper groove 111H may extend radially from the shaft hole 710H.

The stopper groove 111H may have a shape corresponding to the stopper 320. The stopper 320 may be accommodated in the stopper groove 111H. When the stopper 320 is accommodated in the stopper groove 111H, the stopper 320 may be accommodated in the stopper groove 111H and thus movement thereof may be restricted. Accordingly, the rotation of the shaft 300 may be prevented. A more detailed description will be provided later in the description of the stopper 320.

However, the present disclosure is not limited thereto, and the stopper 320 may be located on the case cover 110. The stopper groove 111H may be located on the shaft 300. Hereinafter for convenience of description, it is assumed that the stopper 320 is a component of the shaft 300 and the stopper groove 111H is located on the case cover 110.

The regulator device R may include the shaft 300. The shaft 300 may be configured to be rotatable with respect to the case 100.

The shaft 300 may extend along the front and rear direction.

The shaft 300 may have a pillar shape with a substantially circular cross-section.

The shaft 300 may be positioned by penetrating the case cover 110. The shaft 300 may be movable inside the case 100 along the direction in which the shaft 300 extends.

The shaft 300 may include a metal material. As a result, the shaft 300 may have rigidity that prevents the shaft 300 from breaking due to translational or rotational movement. However, the present disclosure is not limited thereto.

The shaft 300 may be formed through a casting process. However, the present disclosure is not limited thereto.

The shaft 300 may include a shaft body portion 310. The shaft body portion 310 may be a component that defines at least a portion of the exterior of the shaft 300.

At least a portion of the shaft body portion 310 may be inserted into the case 100.

The shaft 300 may include the stopper 320. The stopper 320 may be configured to prevent rotation of the shaft 300.

The stopper 320 may protrude from the shaft body portion 310. The stopper 320 may be accommodated in the stopper groove 111H. While the stopper 320 is accommodated in the stopper groove 111H, the stopper 320 may be in contact with the outer cover 111 to limit rotation of the shaft 300.

The stopper 320 may have a shape corresponding to the stopper groove 111H. The stopper 320 may have a shape similar to the stopper groove 111H. That is, when the cross-section of the stopper 320 is quadrangle, the cross-section of the stopper groove 111H may also have a quadrangle shape. Although the cross section of the stopper 320 and the cross section of the stopper groove 111H correspond to each other, there may be a tolerance to allow the stopper 320 to pass through the stopper groove 111H.

The stopper 320 may protrude from the shaft body portion 310 to be received in the stopper groove 111H while the shaft 300 is at the first shaft position. The stopper 320 may be separated from the stopper groove 111H while the shaft 300 is at the second shaft position.

The shaft 300 may include a shaft flange 330. The shaft flange 330 may be configured to be in contact with the inner cover 113 or the outer cover 111 when the shaft 300 moves forward and backward.

The shaft flange 330 may protrude from the shaft body portion 310 in the radial direction. The shaft flange 330 may extend from the shaft body portion 310 in the circumferential direction.

The shaft flange 330 may have a substantially disk shape.

When the shaft 300 moves forward, the shaft flange 330 may be in contact with the outer cover 111, thereby preventing the shaft 300 from moving forward.

The shaft flange 330 may include a groove stopper 331. The groove stopper 331 may be configured to prevent rotation of the shaft 300 when the shaft 300 is at the first shaft position.

The groove stopper 331 may be located on the shaft flange 330.

The groove stopper 331 may be provided to be concave from an outer diameter of the shaft flange 330 toward a rotation axis of the shaft 300.

The groove stopper 331 may be configured to accommodate a groove stopper locking portion 112.

The groove stopper locking portion 112 may be included in the outer cover 111. The groove stopper locking portion 112 may protrude rearward. The groove stopper locking portion 112 may protrude toward the inner cover 113.

The groove stopper locking portion 112 may have a shape corresponding to the groove stopper 331.

The groove stopper locking portion 112 may be accommodated in the groove stopper 331 when the shaft 300 is at the first shaft position. Accordingly, when attempting to rotate the shaft 300 in a state in which the shaft 300 is at the first shaft position, the groove stopper locking portion 112 may be in contact with the shaft flange 330, thereby limiting the rotation of the shaft 300.

The groove stopper locking portion 112 may be separated from the groove stopper 331 when the shaft 300 is at the second shaft position. Accordingly, when the shaft 300 is rotated in a state in which the shaft 300 is at the second shaft position, there may be no a component that is in contact with the groove stopper locking portion 112 and thus the shaft 300 may rotate.

The shaft 300 may be prevented from moving backward by the case 100.

When the shaft 300 moves rearward, the shaft flange 330 may be in contact with the inner cover 113 so as to prevent the shaft 300 from being separated rearward.

Accordingly, the shaft flange 330 may prevent the shaft 300 from being separated from the case 100.

The shaft 300 may be positioned at the first shaft position. When the shaft 300 is positioned at the first shaft position, the stopper 320 may be accommodated in the stopper groove 111H. That is, the stopper 320 may protrude from the shaft body portion 310 to be accommodated in the stopper groove 111H as the shaft 300 is positioned at the first shaft position.

The shaft 300 may be at the second shaft position. When the shaft 300 is at the second shaft position, the stopper 320 may be spaced apart from the stopper groove 111H by an operating distance.

While the shaft 300 is at the second shaft position, the cam 200 may rotate with the shaft 300, thereby allowing the regulator device R to detect a user input. The cam 200 may be adjacent to the shaft 300 to allow the shaft 300 to be inserted thereinto.

The shaft 300 may include a rotation prevention portion 340. When the rotation prevention portion 340 is accommodated in the cam 200, the rotation prevention portion 340 may be configured to rotate together with the cam 200.

The rotation prevention portion 340 may not be rotationally symmetrical with respect to the rotation axis. The rotation prevention portion 340 may not have a cylindrical shape. The rotation prevention portion 340 may have a shape that is cut along a plane including an extension direction of the cylinder.

The rotation prevention portion 340 may rotate together with the cam 200, and thus the shaft 300 may rotate together with the cam 200. Accordingly, the regulator device R may output a signal corresponding to a user input.

The regulator device R may include the cam 200. The cam 200 may be configured to receive a rotational force from the shaft 300.

The cam 200 may rotate together with the shaft 300.

The cam 200 may be configured to be rotatable on the case body 120. Accordingly, the cam 200 may be rotatable while being supported by the case body 120.

The cam 200 may include a plastic material. However, the present disclosure is not limited thereto.

The cam 200 may be formed through an injection process. However, the present disclosure is not limited thereto.

The regulator device R may include the terminal 201. The terminal 201 may be configured to allow electricity to flow.

The terminal 201 may include the first terminal and the second terminal.

While the first terminal is in contact with the second terminal according to the rotation of the cam 200, the regulator device R may generate a signal based on a user input.

The regulator device R may include a shaft elastic member 301. The shaft elastic member 301 may be configured to press the shaft 300 forward.

The shaft elastic member 301 may be positioned between the shaft 300 and the cam 200.

The shaft elastic member 301 may be configured to press the shaft 300 to allow the stopper 320 to be positioned in the stopper groove 111H. The shaft elastic member 301 may press the rotation prevention portion 340. The shaft elastic member 301 may be in contact with the rotation prevention portion 340. By being compressed by the shaft 300, the shaft elastic member 301 may press the shaft 300 in the direction opposite to the compression.

A user can generate a signal in the regulator device R by pressing and rotating the shaft 300. When the user wishes to stop generating a signal from the regulator device R, the user can release the pressure on the shaft 300 to return the shaft 300 to its original position.

For example, the shaft elastic member 301 may include a compression spring.

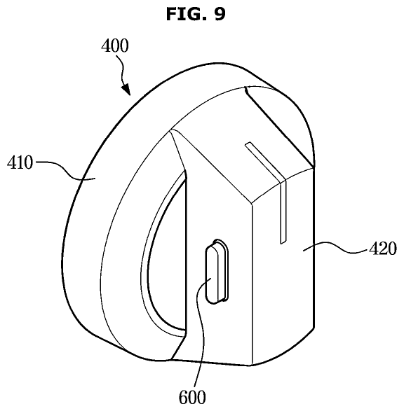

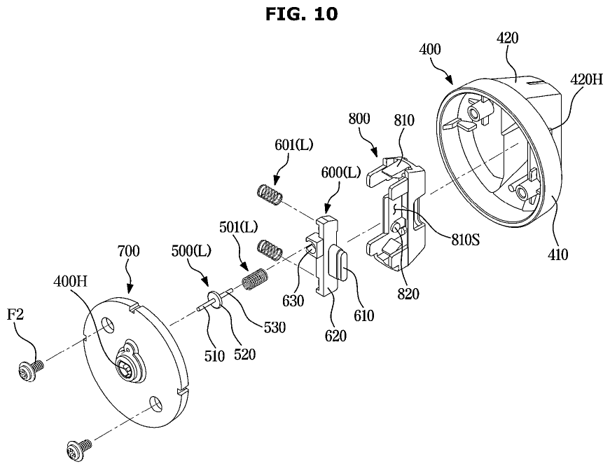

FIG. 9 is a perspective view of the knob assembly N illustrated in FIG. 4. FIG. 10 is an exploded view of the knob assembly N illustrated in FIG. 9.

The knob assembly N according to one embodiment of the present disclosure will be described with reference to FIGS. 9 and 10.

The knob assembly N may include the knob 400. The knob 400 may be a component that defines the exterior of the knob assembly N.

The knob 400 may be provided to be held by a user.

A user can operate the cooking apparatus 1 by holding and pressing or rotating the knob 400.

The knob 400 may include a space formed therein and provided to accommodate other components. The knob 400 may include an opening to accommodate other components therein.

The knob 400 may be positioned in front of other components to cover the other components accommodated therein.

The knob 400 may include a plastic material. However, the present disclosure is not limited thereto.

The knob 400 may be formed by injection molding. However, the present disclosure is not limited thereto.

The knob 400 may include a knob body portion 410.

The knob body portion 410 may have a substantially cylindrical shape.

The knob 400 may include a knob holding portion 420.

The knob holding portion 420 may protrude from the knob body portion 410.

The knob holding portion 420 may have a substantially rectangular parallelepiped shape.

The knob holding portion 420 may be formed not to exceed an outer circumference of the knob body portion 410. That is, a long side of the knob holding portion 420 may have a length equal to or less than a diameter of the knob body portion 410.

A button holder 800, which will be described later, may be accommodated in a space defined by the knob holding portion 420.

The knob holding portion 420 may include a button exposure hole 420H.

At least a portion of a button 600 may be exposed to the outside of the knob 400 through the button exposure hole 420H.

The knob assembly N may include a weight 700. The weight 700 may be configured to cover the opening of the knob 400.

The weight 700 may be positioned adjacent to the knob body portion 410.

The weight 700 may have a shape corresponding to the knob body portion 410. The weight 700 may have a substantially cylindrical shape.

The weight 700 may include a shaft mounting hole 710H.

The shaft 300 may be accommodated in the shaft mounting hole 710H.

The shaft mounting hole 710H may not be circular. Accordingly, when the shaft 300 is accommodated in the shaft mounting hole 710H, the shaft 300 may be rotated by the rotation of the weight 700.

The weight 700 may be formed of metal. As a result, a user can feel the weight of the knob assembly N. However, the present disclosure is not limited thereto. The weight 700 may be formed by a casting process.

The knob assembly N may include the button holder 800. The button holder 800 may be a component for accommodating the button 600, which will be described later.

The button holder 800 may be accommodated in the knob holding portion 420.

The button holder 800 may have a shape corresponding to the knob holding portion 420. The button holder 800 may have a substantially rectangular parallelepiped shape in which one surface is open.

The button holder 800 may define a locking device seating space 810S for accommodating the button 600 therein.

The button holder 800 may be accommodated in the knob 400. The button holder 800 may include the locking device seating space 810S. The button 600 may be accommodated in the locking device seating space 810S.

The button 600 may be positioned adjacent to one surface of the button holder 800 while the button 600 is at a first button position. While the button 600 is moved from the first button position to a second button position, the button 600 may be moved to be closer to the other surface facing one surface of the button holder 800.

The button holder 800 may include a plastic material. However, the present disclosure is not limited thereto.

The button holder 800 may be formed by injection molding. However, the present disclosure is not limited thereto.

The knob assembly N may include a locking device L. The locking device L may be a device configured to lock the movement of the knob 400.

The locking device L may be disposed between the knob 400 and the weight 700.

The locking device L may be configured to restrict the movement of the knob 400.

The locking device L may be provided on the knob 400.

The locking device L may include the button 600. The button 600 may be configured to be operated by a user.

The button 600 may be accommodated inside the button holder 800.

The button 600 may be partially exposed to the outside of the button holder 800. The button 600 may be partially exposed to the outside of the knob 400. A user can move the button 600 by manipulating a portion of the button 600 exposed to the outside of the knob 400.

A space may be defined between the button 600 and the button holder 800. Accordingly, the button 600 may be movable relative to the button holder 800.

The button 600 may be movable to the first button position that limits movement of the locker 500 from a locking position to an unlocking position. The locker 500 may be movable to the second button position that allows the locker 500 to be moved from the locking position to the unlocking position.

A locker receiving space 630S may be located on the button 600.

The button 600 may include a locker contact surface 630A adjacent to an opening of the locker receiving space 630S.

The locker 500 may be at the locking position in contact with the locker contact surface 630A while the button 600 is at the first button position. The locker 500 may be at the unlocking position accommodated in the locker receiving space 630S while the button 600 is at the second button position.

The locking device L may include a button elastic member 601. The button elastic member 601 may be configured to apply an elastic force to the button 600.

The button elastic member 601 may be disposed between the button 600 and the button holder 800. The button elastic member 601 may be configured to press the button 600 and the button holder 800 between an inner surface of the button holder 800 and an outer surface of the button 600. The button holder 800 may be supported by the knob holding portion 420. Accordingly, the button elastic member 601 may press the button 600 to move the button 600.

The button elastic member 601 may be disposed between the knob 400 and the button holder 800 to press the button 600 from the second button position to the first button position.

When the button 600 is pressed by a user, the button 600 may be moved from one side of the button holder 800 to the other side of the button holder 800 that is opposite to the one side and that is with the button elastic member 601 interposed therebetween. The button 600 moved to the other side may be pressed in a direction in which the button elastic member 601 is stretched as the button elastic member 601 is compressed. The button 600 may receive an elastic force from the button elastic member 601 to return to its original position.

A plurality of button elastic members 601 may be provided.

The plurality of button elastic members 601 may include a first button 600a elastic member and a second button 600b elastic member.

While the first button 600a elastic member and the second button 600b elastic member press the button 600 in two portions, the button 600 may move linearly.

The second button 600b elastic member different from the first button 600a elastic member may allow the button 600 to move linearly.

The button 600 may be spaced apart from the button holder 800 in a movable direction. The long side of the button 600 may be moved away from or close to a portion of the button holder 800.

The button 600 may be positioned to allow a portion corresponding to a short side to be adjacent to the button holder 800. As a result, the button 600 may be allowed to move in one direction.

The button 600 may include the locker receiving space 630S provided to accommodate the locker 500, which will be described later.

The button 600 may include a plastic material. However, the present disclosure is not limited thereto.

The button 600 may be formed by injection molding. However, the present disclosure is not limited thereto.

The locking device L may include the locker 500. The locker 500 may be configured to limit the movement of the knob 400.

The locker 500 may be adjacent to the button 600. The locker 500 may restrict the movement of the knob 400 by being in contact with the button 600. When the locker 500 presses the button 600, the button holder 800 in contact with the button 600 may be pressed, and the knob 400 in contact with the button holder 800 may be pressed. Accordingly, the movement of the knob 400 may be prevented.

The locker 500 may be positioned adjacent to the shaft 300 to prevent vibration of the knob 400.

The locker 500 may be moved toward the locker receiving space 630S defined by the button 600. The locker 500 may be aligned with the locker receiving space 630S according to the movement of the button 600. When the locker 500 is aligned with the locker receiving space 630S, the locker 500 may be moved to the locker receiving space 630S. Accordingly, the knob 400 may be movable.

When the knob 400 is moved, the shaft 300 of the regulator device R coupled with the knob 400 may be moved, as described above. The shaft 300 may be moved from the first shaft position to the second shaft position according the movement of the knob 400. When the shaft 300 is moved to the second shaft position, the shaft 300 may be rotated by rotation of the knob 400. By rotating the shaft 300, the regulator device R may operate the heating source 90 of the cooking apparatus 1.

That is, when the locker 500 is aligned with the locker receiving space 630S by moving the button 600, the heating source 90 may be operatable.

The locker 500 may extend in one direction.

The locker 500 may extend in a direction toward the control panel 41.

The locker 500 may be at the locking position between the knob 400 and the control panel 41 to limit movement of the knob 400 while the shaft 300 is at the first shaft position. The locker 500 may be movable to the unlocking position in which at least a portion of the locker 500 is accommodated in the locker receiving space 630S to allow the knob 400 to move.

The locker 500 may include a metal material. Accordingly. the locker 500 may have high rigidity. However, the present disclosure is not limited thereto.

The locker 500 may be formed by a casting process. However, the present disclosure is not limited thereto.

The locking device L may include a locker elastic member 501.

The locker elastic member 501 may be positioned between the locker 500 and the weight 700. The locker elastic member 501 may be configured to press the locker 500 toward the button 600.

The locker elastic member 501 may be a spring.

The knob assembly N may include a knob fastening member F2.

The knob fastening member F2 may fasten the weight 700 and the knob 400.

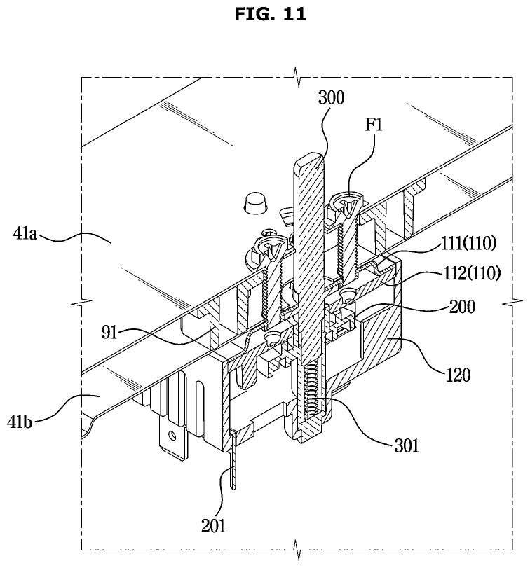

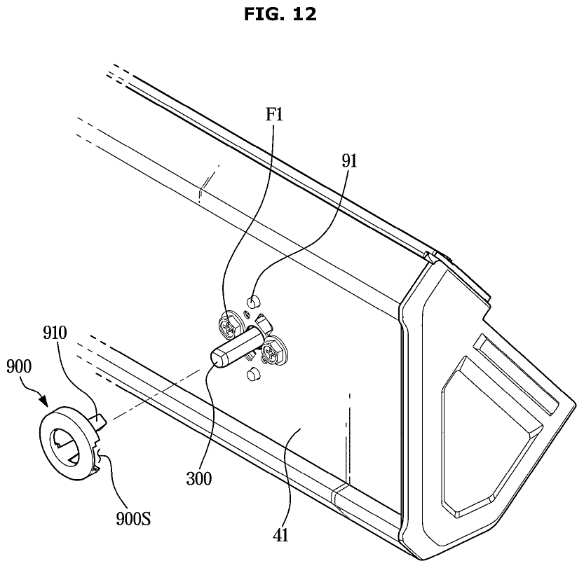

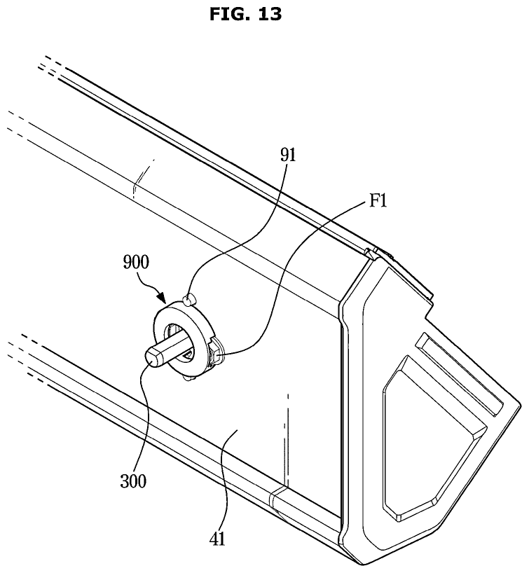

FIG. 11 is a cross-sectional perspective view illustrating a state in which the regulator device R illustrated in FIG. 4 is mounted on the control panel 41. FIG. 12 is a perspective view illustrating a state before the locker supporter 900 is inserted into the control panel 41 illustrated in FIG. 11. FIG. 13 is a perspective view illustrating a state after the locker supporter 900 is inserted into the control panel 41 illustrated in FIG. 12.

A configuration coupled to the control panel 41 according to one embodiment of the present disclosure will be described with reference to FIGS. 11 to 13.

The cooking apparatus 1 may include the control panel 41. The control panel 41 may be a component configured to receive a user input or may be a combination of components configured to receive a user input.

The control panel 41 may have the shape of a flat plate or a shape formed by bending a flat plate.

The control panel 41 may define at least portion of the exterior of the cooking apparatus 1.

The control panel 41 may be located in the front of the regulator body.

The control panel 41 may include a metal material. However, the present disclosure is not limited thereto.

The control panel 41 may be formed through a press process. However, the present disclosure is not limited thereto.

The control panel 41 may include a first control panel 41a and a second control panel 41b located behind the first control panel 41a.

The first control panel 41a may be spaced apart from the second control panel 41b. The control panel 41 may have an insulating effect due to a space between the first control panel 41a and the second control panel 41b.

The cooking apparatus 1 may include a spacing member 91. The spacing member 91 may be configured to form a space between the first control panel 41a and the second control panel 41b.

The spacing member 91 may be disposed between the first control panel 41a and the second control panel 41b. The spacing member 91 may support the first control panel 41a and the second control panel 41b.

The spacing member 91 may be positioned to correspond to the regulator device R.

Because the regulator device R is configured to generate electrical signals, the regulator device R may be vulnerable to heat. Accordingly, the spacing member 91 may be positioned adjacent to the regulator to prevent heat from being transferred to the regulator device R.

The spacing member 91 may be formed of plastic. However, the present disclosure is not limited thereto.

The spacing member 91 may be formed through an injection process. However, the present disclosure is not limited thereto.

The cooking apparatus 1 may include a regulator fastening member F1. The regulator fastening member F1 may be configured to couple the control panel 41 and the regulator device R.

At least a portion of the regulator fastening member F1 may be exposed to the outside of the control panel 41.

The shaft 300 of the regulator device R may be positioned by penetrating the control panel 41. At least a portion of the shaft 300 may be exposed to the outside of the control panel 41.

The regulator fastening member F1 may be positioned adjacent to the shaft 300.

The regulator fastening member F1 may be a screw or rivet.

The cooking apparatus 1 may include the locker supporter 900. The locker supporter 900 may be configured to support the locker 500.

The locker supporter 900 may be configured to surround a hole. The shaft 300 may be positioned by passing through the hole defined by the locker supporter 900.

The locker supporter 900 may be positioned adjacent to the shaft 300.

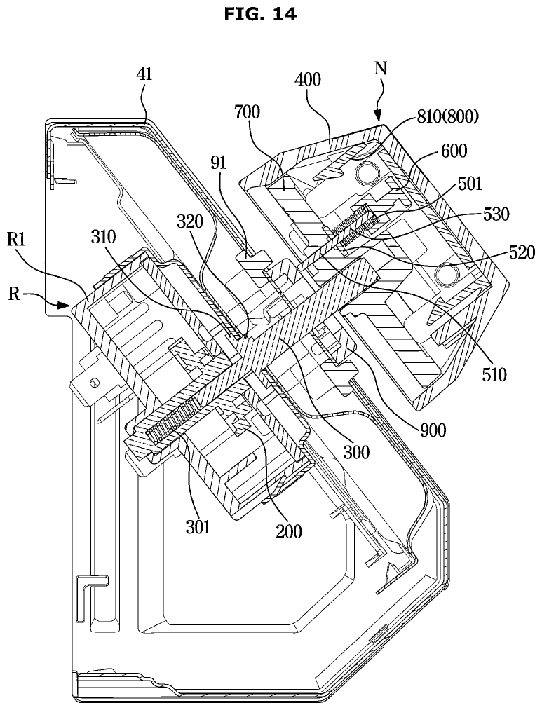

The locker supporter 900 may be positioned to correspond to the locker 500 (FIG. 14).

As will be described later, the locker 500 may be pressed by the knob 400 or rotated according to the rotation of the knob 400. When the knob 400 is rotated while the locker 500 is in contact with the locker supporter 900, a trajectory of the locker 500 in contact with the locker supporter 900 may draw a circle. The locker supporter 900 may have a shape corresponding to a moving trajectory of the locker 500. Accordingly, the locker 500 may come into contact with the locker supporter 900 according to the movement of the locker 500.

As discussed above, the locker 500 may include a metal material. When the locker 500 is rotated and comes into contact with the control panel 41, scratches may be formed on the control panel 41. The control panel 41 is a component that defines at least portion of the exterior of the cooking apparatus 1, and thus when scratches are formed on the control panel 41, the aesthetics of the cooking apparatus 1 may be adversely affected. Furthermore, when the cooking apparatus 1 is used, water may be often used in the container containing the food, and thus water may splash on the control panel 41. When water splashes on the control panel 41 in a state in which the control panel 41 is scratched, corrosion may occur due to reaction with water.

That is, the locker supporter 900 may be mounted on the control panel 41. The locker supporter 900 may be in contact with the locker 500 to prevent scratches that is on the control panel 41 and caused by the locker 500.

The locker supporter 900 may be removably coupled to the control panel 41. As a result, even when a scratch is formed on the locker supporter 900, the locker supporter 900 may be replaced with another locker supporter 900.

The locker supporter 900 may include a plastic material. However, the present disclosure is not limited thereto.

The locker supporter 900 may be formed by injection molding. However, the present disclosure is not limited thereto.

The locker supporter 900 may include a supporter hook portion 910. The supporter hook portion 910 may be inserted into the control panel 41 to couple the locker 500 to the control panel 41.

The supporter hook portion 910 may protrude toward the inside of the regulator body. The supporter hook portion 910 may penetrate the control panel 41.

A plurality of supporter hook portions 910 may be provided. The plurality of supporter hook portions 910 may be positioned symmetrically. As a result, the locker supporter 900 may be stably coupled to the control panel 41.

The control panel 41 may include a hole into which the supporter hook portion 910 is inserted.

The locker supporter 900 may include a fastening member receiving space 900S.

The regulator fastening member F1 may be accommodated in the fastening member receiving space 900S.

As mentioned above, a portion of the regulator fastening member F1 may be exposed to the outside of the control panel 41. When the trajectory, which is drawn as the locker 500 rotates, overlaps the position of the regulator fastening member F1, the locker supporter 900 may cover the front side of the regulator fastening member F1 to support the locker 500 while locker 500 moves. For this, the regulator fastening member F1 may be accommodated in the fastening member receiving space 900S.

The fastening member receiving space 900S may be concave toward the front.

In the case of a portion other than the portion in which the fastening member receiving space 900S of the locker supporter 900 is located, a portion in contact with the control panel 41 and the fastening member receiving space 900S is located, may come into contact with the regulator fastening member F1.

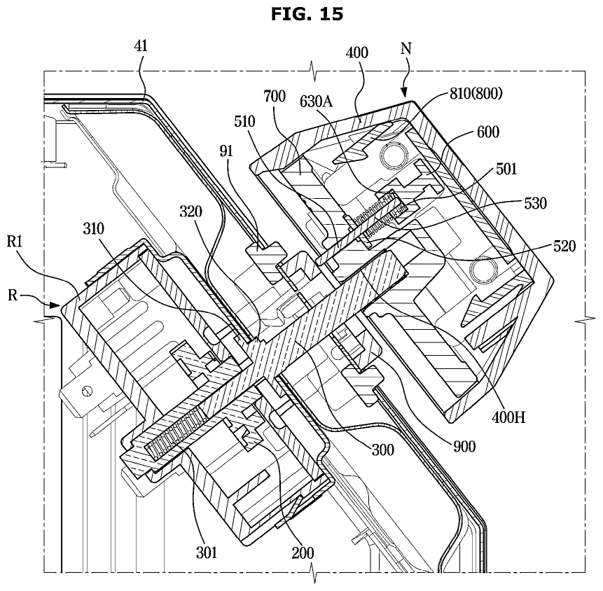

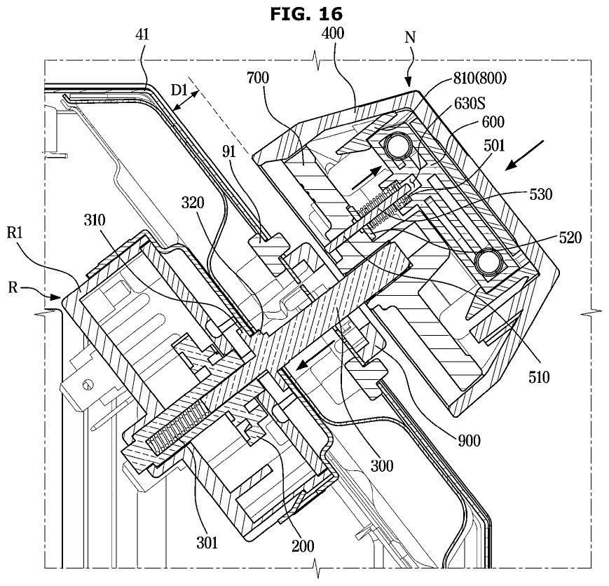

FIG. 14 is a cross-sectional view mainly illustrating the knob assembly N and the regulator device R of the cooking apparatus 1 illustrated in FIG. 3. FIG. 15 is a cross-sectional view mainly illustrating the knob assembly N illustrated in FIG. 14. FIG. 16 is a cross-sectional view illustrating a state in which the button 600 is pressed in the knob assembly N illustrated in FIG. 15.

The movement of the knob assembly N according to one embodiment of the present disclosure will be briefly described with reference to FIGS. 14 to 16.

The cooking apparatus 1 may include the regulator device R. The regulator device R may be in contact with the terminal 201 by rotation of the shaft 300.

Particularly, the cam 200 may rotate due to the rotation of the shaft 300, and the first terminal 201 (not shown) may move due to the rotation of the cam 200 to be in contact with the second terminal 201 (not shown). When the first terminal 201 and the second terminal 201 come into contact, electricity may flow. A signal may be transmitted to the heating source 90 by an electrical signal.

The cooking apparatus 1 may include the controller 1000.

The controller 1000 may include the processor 1100 and the memory 1200.

The processor 1100 may include a program (a plurality of instructions) for processing signals and providing control signals.

The memory 1200 may include a volatile memory 1200 such as Static Random Access Memory (S-RAM) and Dynamic Random Access Memory (D-RAM), and a non-volatile memory 1200 such as Read Only Memory (ROM), and Erasable Programmable Read Only Memory (EPROM).

The memory 1200 may be provided integrally with the processor 1100 or may be provided as a semiconductor device separate from the processor 1100.

The processor 1100 may further include a processing core (e.g., a memory circuit and a control circuit) configured to process signals based on the program or data stored in the memory 1200 and configured to output a control signal.

When the first terminal 201 and the second terminal 201 are in contact, the regulator device R may generate a signal for the processor 1100 to receive.

The processor 1100 may control the heating source 90 to allow the heating source 90 to operate based on a user input detected by the regulator device R.

The processor 1100 may control the heating source 90 to operate the heating source 90 based on a signal generated in response to a user input from the regulator device R.

However, in order to allow the cam 200 to rotate through the rotation of the shaft 300, the shaft 300 may need to be at the second shaft position.

This is because when the shaft 300 is at the first shaft position, the stopper 320 (FIG. 5) is received in the stopper groove 111H (FIG. 5), thereby limiting rotation of the shaft 300.

Accordingly, the regulator device R may be operated only when the shaft 300 is moved from the first shaft position to the second shaft position.

The knob assembly N may be coupled to the shaft 300. The knob assembly N may be moved together with the shaft 300. That is, as the knob assembly N moves, the shaft 300 may be moved from the first shaft position to the second shaft position. The shaft 300 may rotate as the knob assembly N rotates. A user can control the movement of the shaft 300 by manipulating the knob assembly N. A user can control the regulator device R by manipulating the knob assembly N. A user can control the heating source 90 by manipulating the knob assembly N.

The control panel 41 may be located between the knob assembly N and the regulator body. The shaft 300 may be positioned by penetrating the control panel 41.

The locker supporter 900 may be located on one side of the control panel 41 facing the knob assembly N.

The knob assembly N may include the knob 400 and the weight 700. The knob 400 and the weight 700 may be coupled and moved together.

A space may be provided between the knob 400 and the weight 700. At least a portion of the locker 500 may be located in the space provided between the knob 400 and the weight 700.

The knob 400 may be in a first knob position in which the shaft 300 is at the first shaft position and a second knob position in which the shaft 300 is at the second shaft position.

The locker 500 may extend toward the locker supporter 900.

The locker 500 may include a locker contact portion 510.

The locker contact portion 510 may protrude to the outside of the weight 700.

The locker contact portion 510 may be in contact with the locker supporter 900 when the knob 400 is at the first knob position. As a result, the movement of the knob assembly N toward the locker supporter 900 may be restricted. Accordingly, the locker contact portion 510 may restrict the movement of the shaft 300 from the first shaft position to the second shaft position.

The locker 500 may include a locker support portion 520.

The locker support portion 520 may extend outwardly in the radial direction of the locker 500. The locker support portion 520 may extend along the circumferential direction of the locker 500. Accordingly, the locker elastic member 501 may be supported.

The locker support portion 520 may have a substantially disk shape.

The locker support portion 520 may be in contact with the weight 700 when the knob 400 is at the first knob position.

The locker 500 may include a locker extending portion 530.

The locker extending portion 530 may protrude toward the button 600.

The locker extending portion 530 may be in contact with the button 600 when the knob 400 is at the first knob position. Accordingly, the movement of the button 600 toward the locker 500 may be restricted. Therefore, the locker extending portion 530 may restrict the movement of the shaft 300 from the first shaft position to the second shaft position.

As shown in FIG. 15, when the button 600 is at the first button position, the locker extending portion 530 may be in contact with the button 600. That is, the locker 500 may be located in the locking position. In this case, the movement of the knob 400 from the first knob position to the second knob position may be restricted due to contact between the button 600 and the locker 500. When knob 400 is at the first knob position, the shaft 300 may be at the first shaft position. When the button 600 is at the first button position, the shaft 300 may not be allowed to move from the first shaft position to the second shaft position.

As shown in FIG. 16, when the button 600 is at the second button position, the locker receiving space 630S located on the button 600 may be aligned with the locker extending portion 530. In this case, the locker 500 may be moved forward. The locker 500 may be moved from the locking position to the unlocking position. As the locker 500 is movable, the knob 400 may be allowed to move from the first knob position to the second knob position. When the knob 400 is at the second knob position, the shaft 300 may be at the second shaft position. When the button 600 is at the second button position, the shaft 300 may be allowed to move from the first shaft position to the second shaft position.

At this time, when the locker 500 is moved from the locking position to the unlocking position, it is required that the shaft 300 move by a distance that allows the stopper 320 of the shaft 300 to deviate from the stopper groove 111H. Therefore, when the locker 500 is at the unlocking position, a distance by which the knob 400 is moved from the first knob position to the second knob position may be greater than or equal to a distance by which the shaft 300 is moved from the first shaft position to the second shaft position.

That is, the distance by which the locker 500 is moved from the locking position to the unlocking position may be greater than or equal to the distance by which the shaft 300 is moved from the first shaft position to the second shaft position.

When the locker 500 is in contact with the locker supporter 900 at the locking position, the knob 400 may be moved from the first knob position to the second knob position by the distance by which the locker 500 is moved from the locking position to the unlocking position. Therefore, in this case, the distance by which the locker 500 is moved from the locking position to the unlocking position may be greater than or equal to the distance by which the shaft 300 is moved from the first shaft position to the second shaft position.

When the shaft 300 is moved to the second shaft position, the shaft 300 may be rotated by rotation of the knob 400. When the shaft 300 is rotated, the terminal 201 may be in contact by the rotation of the cam 200, and thus a current may flow through the terminal 201. When a current flows through the terminal 201, the controller 1000 may detect the flow of the current and the controller 1000 may control the heating source 90 to operate.

When the button 600 is moved from the second button position to the first button position, an operation occurs in the reverse order of the previously described case.

When moving the button 600 from the first button position to the second button position, a user may need to press the button 600. When a user does not press the button 600, the button 600 may be pressed by the button elastic member 601 (FIG. 10) and moved from the second button position to the first button position. In this case, when a user does not press the knob 400 rearward, the shaft 300 may be moved from the second shaft position to the first shaft position. This is because the shaft 300 is pressed by the shaft elastic member 301.

While the button 600 is moved from the first button position to the second button position, the locker 500 and the locker receiving space 630S may not be aligned. In this case, the locker 500 may be moved from the unlocking position to the locking position. This is because the locker elastic member 501 presses the locker 500 to move from the unlocking position to the locking position.

In the above, it has been described that the movement of the locker 500 is due to the position of the locker receiving space 630S aligned with the locker 500 by the button 600. Hereinafter a method in which the locker receiving space 630S is aligned with the locker 500 will be described.

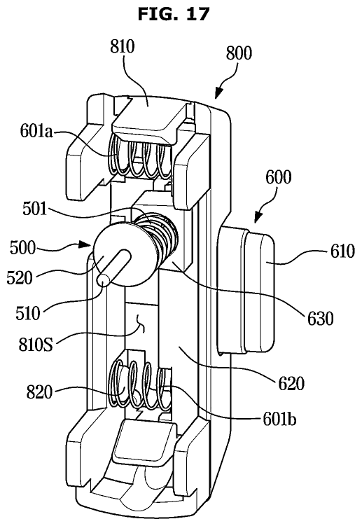

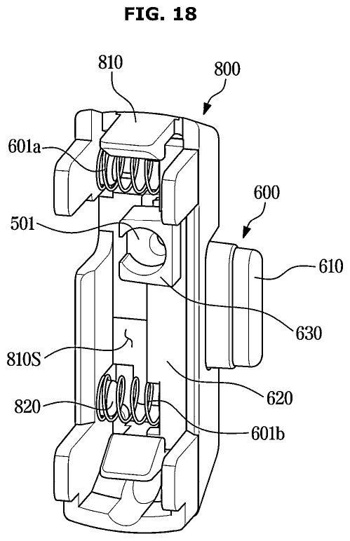

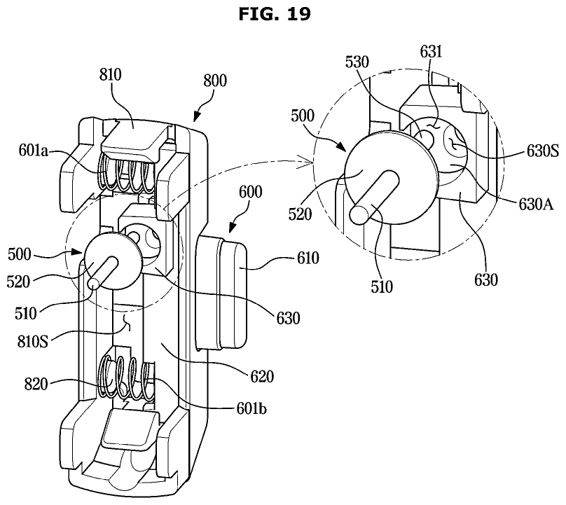

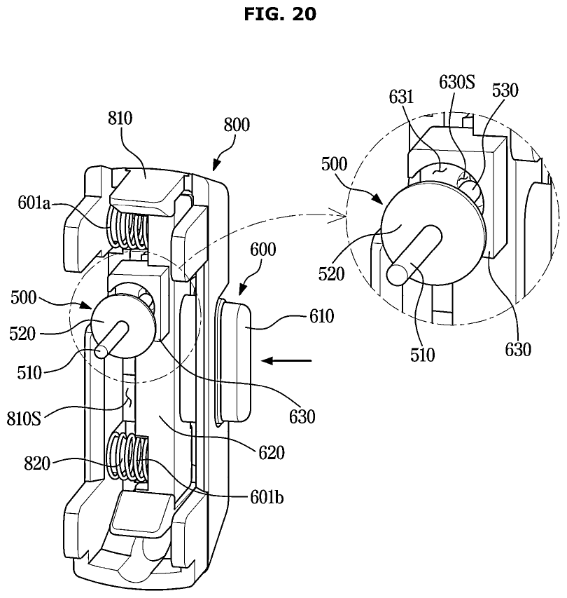

FIG. 17 is a perspective view illustrating the locker 500 of the knob assembly N illustrated in FIG. 15 and a configuration related thereto. FIG. 18 is a front view illustrating the button 600 inserted into the button holder 800 illustrated in FIG. 17. FIG. 19 is an enlarged perspective view illustrating a state before the locker 500 is inserted into the locker receiving space 630S in the configuration related to the locker 500 illustrated in FIG. 17. FIG. 20 is an enlarged perspective view illustrating a state after the locker 500 is inserted into the locker receiving space 630S in the configuration related to the locker 500 illustrated in FIG. 18.

Movements of the button 600 and the locker 500 according to one embodiment of the present disclosure will be described with reference to FIGS. 17 to 19.

The knob assembly N may include the button 600.

The button 600 may include a button body 620. The button body 620 may be a component that defines the exterior of the button 600.

The button body 620 may be accommodated in the button holder 800.

The button 600 may include a button holding portion 610. The button holding portion 610 may be exposed to the outside of the knob 400.

The button holding portion 610 may protrude from the button body 620. The button holding portion 610 may protrude toward the outside of the button holder 800.

The button elastic member 601 may be located on one side of the button body 620 opposite to one side on which the button holding portion 610 protrudes. The button elastic member 601 may be positioned between the button body 620 and the button holder 800. Accordingly, the button elastic member 601 may press the button body 620 to allow the button holding portion 610 to move outward from the knob 400.

The button holder 800 may include an elastic member insertion protrusion 820 into which the button elastic member 601 is inserted.

The elastic member insertion protrusion 820 may protrude toward the button body 620.

The button 600 may be slidably moved while being moved from the first button position to the second button position. A space may be located between the button body 620 and the button holder 800. While the button body 620 is moved into the space, the button 600 may be moved from the first button position to the second button position.

The button holder 800 may include a guide hook portion 810. The guide hook portion 810 may guide the slide movement of the button 600.

The guide hook portion 810 may be positioned adjacent to the button 600 to guide the movement of the button 600. The guide hook portion 810 may protrude toward the control panel 41.

The guide hook portion 810 may include a hook shape at an end thereof. Accordingly, the button 600 may be prevented from being separated from the button holder 800.

The guide hook portion 810 may extend along the locker 500.

The guide hook portion 810 may extend along the direction in which the button 600 is moved from the first button position to the second button position. The button 600 may be slidably moved along the guide hook portion 810.

The button elastic member 601 may include the first button 600a elastic member and the second button 600b elastic member. The first button 600a elastic member and the second button 600b elastic member may be configured to slide by dispersing a pressing force while moving the button 600 from the second button position to the first button position.

The button 600 may include an elastic member receiving portion 630. The elastic member receiving portion 630 may be provided to accommodate the locker elastic member 501.

The elastic member receiving portion 630 may protrude toward the locker support portion 520 (FIG. 15). The elastic member receiving portion 630 may include a space in which the elastic member is accommodated. The elastic member may be accommodated in the elastic member receiving portion 630 and a position of the elastic member may be fixed.

The locker contact surface 630A may be provided inside the elastic member receiving portion 630.

The locker extending portion 530 of the locker 500 may be in contact with the locker contact surface 630A when the locker 500 is at the locking position. Accordingly, when the button 600 is at the first button position, the movement of the knob 400 from the first knob position to the second knob position may be restricted.

The locker elastic member 501 may be in contact with the locker contact surface 630A. The locker elastic member 501 may be positioned between the locker contact surface 630A and the locker support portion 520.

The locker receiving space 630S may be positioned adjacent to the locker contact surface 630A. When the button 600 is moved from the first button position to the second button position, the locker receiving space 630S may be moved toward the locker 500.

When the button 600 is at the first button position, the locker receiving space 630S may be located in a direction opposite to the direction in which the button 600 faces the second button position with respect to the locker 500.

When the button 600 is at the first button position, the locker receiving space 630S may be positioned to be spaced apart from the position of the locker 500 by the distance by which the button 600 is moved from the first button position to the second button position.

Accordingly, when the button 600 is moved from the first button position to the second button position, the locker 500 may be aligned with the locker receiving space 630S. Particularly, when the button 600 is at the second button position, the locker receiving space 630S may be located in front of the locker extending portion 530 of the locker 500. Therefore, while the knob 400 is moved from the first knob position to the second knob position, the locker extending portion 530 of the locker 500 may be moved to the locker receiving space 630S and at same time, the movement of the knob 400 may be allowed. As the movement of the knob 400 is allowed, the shaft 300 may be movable from the first shaft position to the second shaft position.

A direction in which the button 600 is moved from the first button position to the second button position may intersect with a direction in which the locker 500 is moved from the locking position to the unlocking position. Accordingly, a user can easily press the button 600, and at the same time, necessary movement of the locker 500 may be allowed.

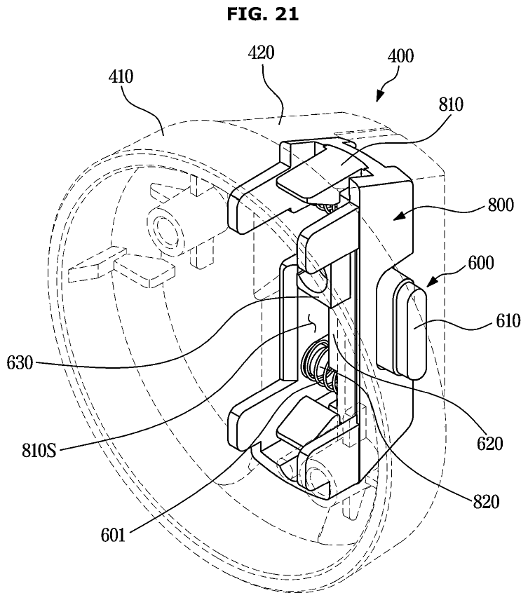

FIG. 21 is a perspective view illustrating a state in which the button holder 800 and a configuration related thereto illustrated in FIG. 17 is inserted into the knob 400.

A positional relationship between the button holder 800 and the knob 400 according to one embodiment of the present disclosure will be described with reference to FIG. 21.

The knob 400 may include the knob body portion 410 and the knob holding portion 420 protruding from the knob body portion 410.

The button holder 800 may be located inside the knob holding portion 420. The button holder 800 may have a shape corresponding to the knob holding portion 420.

The button holder 800 may be affected by the shape of the knob holding portion 420. A movable distance of the button 600 from the first button position to the second button position may be affected by the shape of the button holder 800. Particularly, the movable distance of the button 600 from the first button position to the second button position may be affected by a width of the button holder 800. In other words, the movable distance of the button 600 may be determined by the knob holding portion 420.

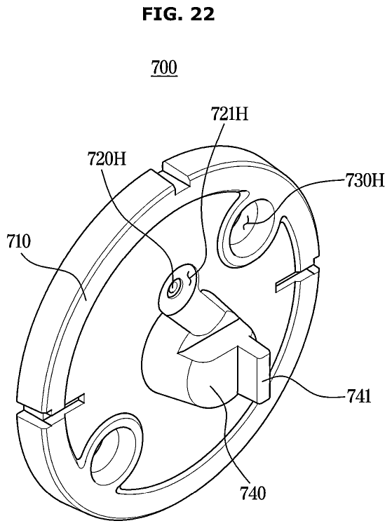

FIG. 22 is a perspective view illustrating the weight 700 illustrated in FIG. 10.

The weight 700 according to one embodiment of the present disclosure will be described in detail with reference to FIG. 22.

The knob assembly N may include the weight 700.

The weight 700 may include a weight body 710. The weight body 710 may define at least portion of the exterior of the weight 700.

The weight 700 may include a weight protrusion 740.

The weight protrusion 740 may protrude toward the button 600.

The weight protrusion 740 may include a button movement limiter 741.

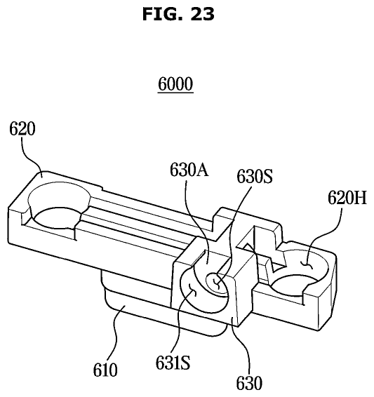

The button movement limiter 741 may be in contact with the button body 620 (FIG. 23) while the button 600 is at the second button position. As a result, it is possible to guide that the button 600 is at the second button position.

The button 600 may be required to be accurately positioned at the second button position. When the button 600 is at the second button position, the position of the locker receiving space 630S may be required to be aligned to correspond to the locker 500. This is because the locker receiving space 630S needs to be positioned to correspond to the locker 500 in order that the locker 500 is moved from the locking position to the unlocking position.

For this, the button movement limiter 741 may restrict further movement by being in contact with the button body 620 when the button 600 is moved to the second button position.

That is, the button movement limiter 741 may protrude in an opposite direction facing the control panel 41 to be in contact with the button 600 when the button 600 is at the second button position to guide movement of the button 600 to the second button position.

The weight 700 may include a fastening member hole 730H into which the knob fastening member F2 is insertable.

The weight 700 may include a locker hole 720H through which the locker 500 passes. The locker hole 720H may be positioned to correspond to the locker contact portion 510.

The weight 700 may be positioned over the opening of knob 400. The locker 500 may pass through the locker hole 720H so as to be exposed to the outside of the weight 700.

The weight 700 may include a flange receiving recess 721H that is concave toward the opposite direction of the locker support portion 520 to accommodate the locker support portion 520 of the locker 500. The flange receiving recess 721H may be positioned to correspond to the locker support portion 520. Accordingly, the locker support portion 520 may be positioned at an accurate position.

FIG. 23 is a perspective view illustrating the button 600 illustrated in FIG. 10.

The button 600 according to one embodiment of the present disclosure will be described with reference to FIG. 23.

The knob assembly N may include the button 600.

The button 600 may include the button body 620.

The button 600 may include the button holding portion 610. The button holding portion 610 may protrude from the button body 620 toward the outside of the knob 400.

The button 600 may include an elastic member receiving space 631S. The elastic member receiving space 631S may extend in a direction crossing the direction in which the button 600 is moved from the first button position to the second button position. The elastic member receiving space 631S may extend in a direction perpendicular to the direction in which the button 600 is moved. Accordingly, the button 600 may be pressed in a direction different from the direction in which the locker 500 (FIG. 10) receives elastic force by the locker elastic member 501 (FIG. 10). When the direction in which the button 600 is moved from the first button position to the second button position is similar to the moving direction of the locker 500, the knob assembly N may be pressed simultaneously with the operation of the button 600. As a result, the regulator device R may operate due to the movement of the shaft 300. In order to prevent this, it is appropriate that the moving direction of the button 600 is different from the moving direction of the shaft 300.

The locker 500 may include the elastic member receiving portion 630. The elastic member receiving portion 630 may extend from the button body 620 along the direction in which the locker 500 is moved from the locking position to the unlocking position. The elastic member receiving portion 630 may define the elastic member receiving space 631S.

The button 600 may include the locker receiving space 630S. The locker receiving space 630S may extend along a direction parallel to the direction in which the elastic member receiving space 631S extends. Accordingly, the locker elastic member 501 may apply an elastic force to the locker 500 in a direction parallel to the direction in which the locker 500 is moved.

The button 600 may include an elastic member recess. The elastic member recess may be a space in which the button elastic member 601 is accommodated. As a result, the button elastic member 601 may be stably positioned between the button 600 and the button holder 800.

The elastic member recess may be located adjacent to the end of the button body 620.

A plurality of elastic member recesses may be provided. The elastic member recess may include a first elastic member recess 620Ha and a second elastic member recess 620Hb.

The first elastic member recess 620Ha and the second elastic member recess 620Hb may be located at both ends of the button body 620 perpendicular to the moving direction of the button 600.

The cooking apparatus 1 according to one embodiment of the present disclosure has been described in the above-description. Hereinafter a cooking apparatus 1 according to another embodiment of the present disclosure will be described. Configurations that are the same as those shown in FIGS. 1 to 23 may be assigned the same reference numerals and descriptions thereof may be omitted.

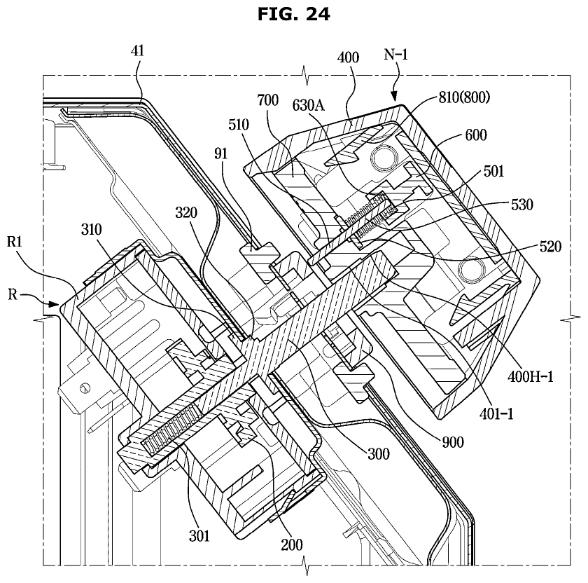

FIG. 24 is a cross-sectional view of a knob assembly N-1 and a configuration related thereto according to one embodiment of the present disclosure.

The regulator combination of the knob assembly N-1 according to one embodiment of the present disclosure will be described with reference to FIG. 24.

The knob assembly N may include a shaft rotation portion 400H-1. The shaft rotation portion 400H-1 may define a space in which a shaft 300 is located.

The knob assembly N-1 may be removably coupled to the shaft 300. The knob assembly N-1 may be separated from the shaft 300 to facilitate cleaning, and the knob assembly N-1 may be coupled to the shaft 300 after cleaning.

A space defined by the shaft rotation portion 400H-1 may extend parallel to a direction in which a shaft mounting hole 710H-1 extends. The space defined by the shaft rotation portion 400H-1 may have a circular cross-section. The space defined by the shaft rotation portion 400H-1 may have a cylindrical shape.

The shaft 300 may be located inside the shaft rotation portion 400H-1. When the shaft 300 is located inside the shaft rotation portion 400H-1 and the shaft 300 is not accommodated in the shaft mounting hole 710H-1, the shaft 300 may not be rotated despite the rotation of the knob 400. In this case, the shaft 300 may need to be moved further inside the knob assembly N to be accommodated in the shaft mounting hole 710H-1.

The shaft rotation portion 400H-1 may not be provided in the knob assembly N-1. In a state in which the knob assembly N-1 is not close enough to the shaft 300 and the knob 400 is pressed to move from the first knob position toward the second knob position, the shaft 300 may be moved to an end portion of the shaft mounting hole 710H-1. That is, even when the knob 400 moves, the shaft 300 may not move from the first shaft position to the second shaft position. Because a user expects the movement of the shaft 300 to occur according to the movement of the knob 400, the user can attempt to rotate the knob 400. In this case, the stopper 320 of the shaft 300 may be caught in the stopper groove 111H, thereby restricting rotation. In this case, the user may not obtain the desired operation.

To prevent this, a user can mount the knob assembly N-1 to the shaft 300 after moving the locker 500 from the locking position to the unlocking position by moving the button 600 from the first button position to the second button position. In order for the shaft 300 to be positioned adjacent to the end portion of the shaft mounting hole 710H-1, it is possible for the locker 500 to prevent the limitation in the movement of the knob assembly N by being in contact with the supporter.

However, because it is difficult for a user to know that the knob assembly N-1 is deeply coupled to the shaft 300, the shaft rotation portion 400H-1 may be provided. Accordingly, when the shaft 300 is not inserted sufficiently to the knob assembly N-1, the user can feel that the knob 400 is idling. Accordingly, the user can recognize that the knob assembly N-1 is not sufficiently coupled to the shaft 300. When there is idle rotation of the knob assembly N-1, the user can manipulate the knob assembly N-1 to press the button 600 to couple the shaft 300 to the knob assembly N-1, more deeply.

In the embodiment referring to FIGS. 1 to 23, the shaft rotation portion 400H-1 is not provided. Accordingly, a contact area between the shaft 300 and the knob assembly N is increased to allow the shaft 300 and the knob assembly N to be stably coupled. The present embodiment is different in that the shaft rotation portion 400H-1 is provided to allow a user to recognize that the knob assembly N-1 is coupled to the shaft 300 at the accurate position.

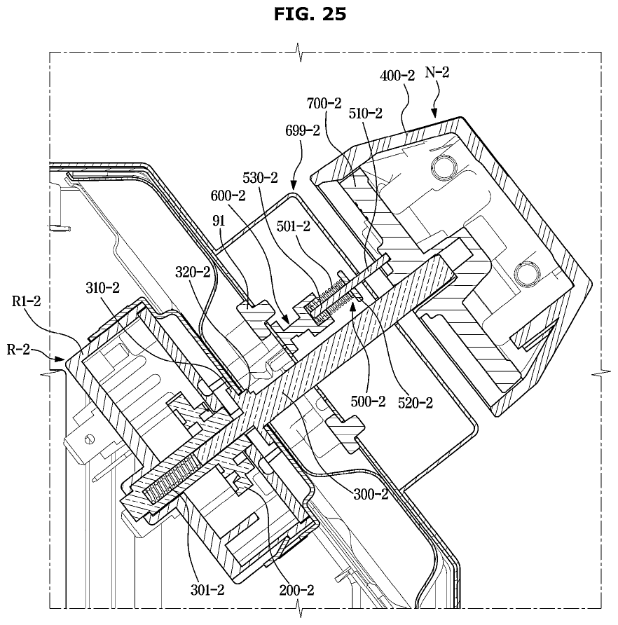

FIG. 25 is a cross-sectional view of a knob assembly N-2 and a configuration related thereto according to one embodiment of the present disclosure.

The knob assembly N-2 according to one embodiment of the present disclosure will be described with reference to FIG. 25.

A locker housing 699-2 may be provided in a control panel 41. The locker housing 699-2 may be provided to accommodate the following component.

The locker housing 699-2 may be disposed between the control panel 41 and the knob assembly N-2.

The locker housing 699-2 may include a space formed therein.

A shaft 300 may penetrate the locker housing 699-2 and be coupled to the knob assembly N-2.

A button 600-2, a button elastic member 601-2, a locker 500-2, and a locker elastic member 501-2 may be disposed inside the locker housing 699-2.

The locker 500-2 may include a locker contact portion 510 facing the shaft 300. The locker contact portion 510 may be in contact with the knob assembly N-2.

The locker elastic member 501-2 may press the locker 500-2 to allow the locker 500-2 to be pressed toward the knob assembly N-2.

The locker 500-2 may be in contact with the knob assembly N-2 at the locking position. The locker 500-2 may be in contact with a weight 700 at the locking position.

When the button 600-2 is moved from the first button position to the second button position, the locker 500-2 may be aligned with the locker receiving space 630S-2. The locker receiving space 630S-2 may be located within the locker housing 699-2.

The locker 500-2 may be positioned toward the control panel 41 while being moved from the locking position to the unlocking position.

While the button 600-2 is moved from the first button position to the second button position, the knob 400 may be movable from the first knob position to the second knob position. When the knob 400 is moved to the second knob position, the shaft 300 may be moved from the first shaft position to the second shaft position. When shaft 300 is at the second shaft position, the shaft 300 may rotate. When the shaft 300 rotates, the regulator device R may generate a signal to operate the heating source 90.

In the embodiment shown in FIGS. 1 to 23, the knob assembly N includes the locking device L. The locking device L may be disposed inside the knob 400. In the embodiment, a locking device L-2 may be located inside the locker housing 699-2 located adjacent to the control panel 41.

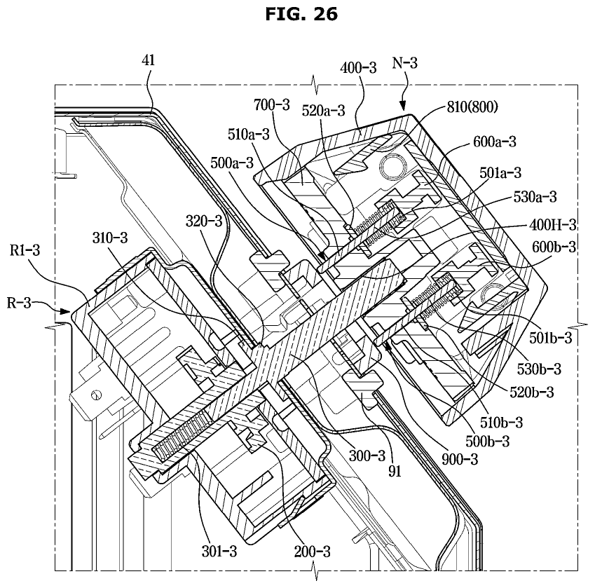

FIG. 26 is a cross-sectional view of a knob assembly N and a configuration related thereto according to one embodiment of the present disclosure.

The knob assembly N-3 according to one embodiment of the present disclosure will be described with reference to FIG. 26.

The knob assembly N-3 may include a first button 600a-3 and a second button 600b-3.

The first button 600a-3 and the second button 600b-3 may be positioned symmetrically with respect to the shaft 300.

The knob assembly N-3 may include a first locker 500a-3 and a second locker 500b-3.

The first locker 500a-3 and the second locker 500b-3 may be positioned symmetrically with respect to the shaft 300.

The first locker 500a-3 and the second locker 500b-3 may be in contact with a locker supporter 900.

The first locker 500a-3 and the second locker 500b-3 press the locker supporter 900 symmetrically with respect to the shaft 300. Accordingly, when a knob 400 is moved from the first knob position to the second knob position, the knob 400 may be pressed horizontally with respect to the shaft 300.

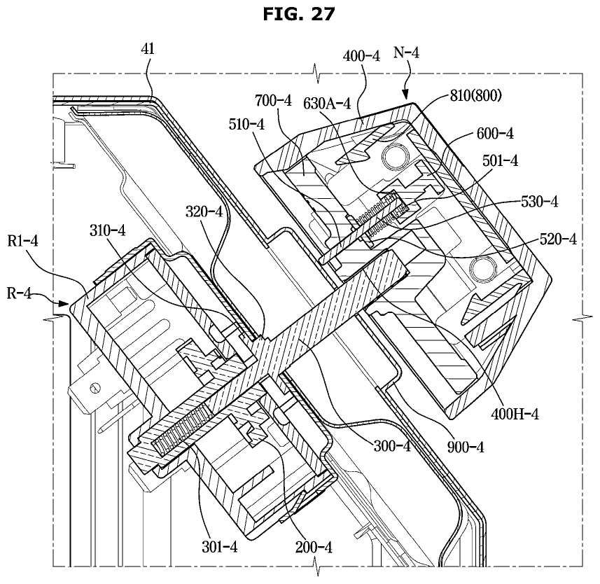

FIG. 27 is a cross-sectional view of a knob assembly N and a configuration related thereto according to one embodiment of the present disclosure.

A locker supporter 900-4 according to one embodiment of the present disclosure will be described with reference to FIG. 27.

A control panel 41 may include the locker supporter 900-4.

The locker supporter 900-4 may be provided to extend from a portion of the control panel 41.

The locker supporter 900-4 may be formed together in a process of forming the control panel 41. As a result, the process may be simplified by not including a separate locker supporter 900-4.

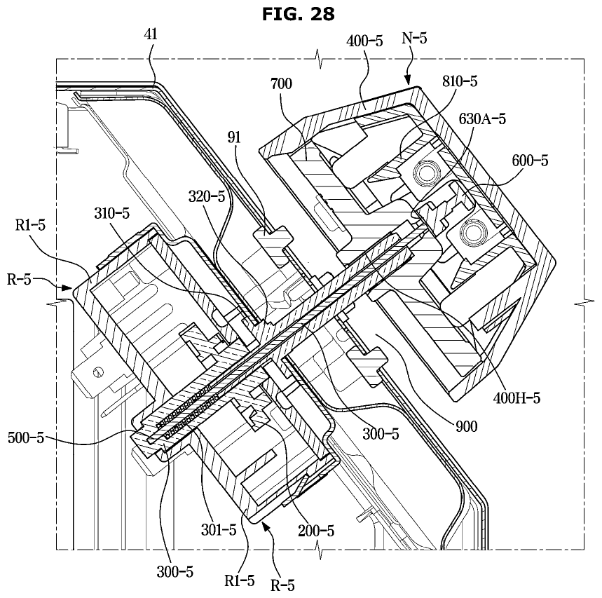

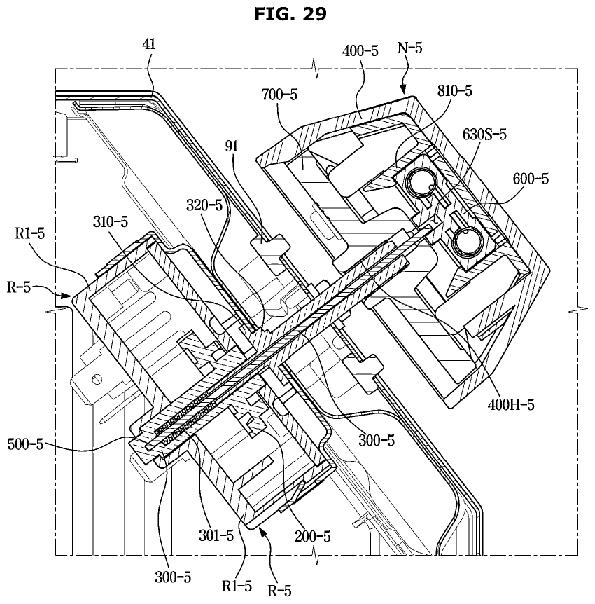

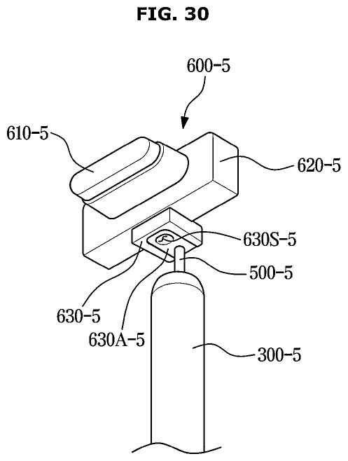

FIG. 28 is a cross-sectional view of a knob assembly N-5 and a configuration related thereto according to one embodiment of the present disclosure. FIG. 29 is a cross-sectional view illustrating a state in which a button 600-5 of the knob assembly N-5 illustrated in FIG. 28 is pressed. FIG. 30 is a perspective view illustrating the button 600-5, a locker 500-5 and a shaft 300-5 before the locker 500-5 shown in FIG. 28 is accommodated in a locker 500-5 insertion space.

The locker 500-5 according to one embodiment of the present disclosure will be described with reference to FIGS. 28 to 30.

The locker 500-5 may extend along a direction in which the shaft 300-5 extends.

The locker 500-5 may be positioned by penetrating the shaft 300-5. The locker 500-5 may be located inside the shaft 300-5. The locker 500-5 may be exposed to the outside of the shaft 300-5 at an end of the shaft 300-5 facing the knob assembly N-5.

One end of the locker 500-5 may be exposed to the outside of the shaft 300-5, and the other end of the locker 500-5 may be in contact with the inside of the shaft 300-5.

The shaft 300-5 may include a hole for accommodating the locker 500-5. The hole defined in the shaft 300-5 may extend in a longitudinal direction of the shaft 300-5.

A weight 700-5 may include a hole through which the locker 500-5 passes to allow the locker 500-5 to be in contact with the button 600-5. The locker 500-5 may be positioned to pass through the hole defined in the weight 700-5.

The locker 500-5 may be in contact with the button 600-5 provided inside the knob 400.

The locker 500-5 may be located in the locking position. However, when the button 600-5 is moved from the first button position to the second button position, the locker receiving space 630S may be located adjacent to an end portion of the locker 500-5.

When the knob 400 attempts to move from the first knob position to the second knob position in a state in which the button 600-5 is at the first button position, the end portion of the locker 500-5 may come into contact with the knob 400 and thus the movement of the knob 400 may be restricted.

When the knob 400 attempts to move from the first knob position to the second knob position in a state in which the button 600-5 is at the second button position, the end portion of the locker 500-5 may be accommodated in the locker receiving space 630S and thus the movement of the knob 400 may be allowed.

When the knob 400 is moved to the second knob position, the shaft 300-5 may be moved to the second shaft position and thus the regulator device R may operate the heating source 90.

In the embodiment, the locker elastic member 501 may not be required.

Therefore, in the button 600-5, an elastic member receiving portion 630-5 protruding from the button body 620 toward the locker 500-5 may not define a separate elastic member receiving space 631S.

When the button 600-5 is at the first button position, the elastic member receiving portion 630-5 may include a locker contact surface 630A-5 in contact with the locker 500-5.

When the button 600-5 is at the second button position, the elastic member receiving portion 630-5 may include a locker receiving space 630S-5 configured to accommodate the locker 500-5.

The locker receiving space 630S-5 may be positioned adjacent to the locker contact surface 630A-5.

Hereinafter another embodiment of the shape of the locker 500 will be described.

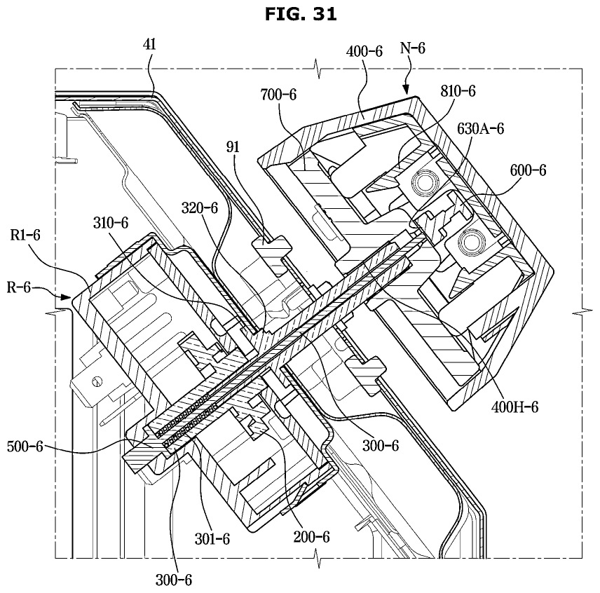

FIG. 31 is a cross-sectional view of a knob assembly N-6 and a configuration related thereto according to one embodiment of the present disclosure.

A locker 600-6 according to one embodiment of the present disclosure will be described with reference to FIG. 31.

The locker 600-6 may extend along a direction in which a shaft 300-6 extends.

The locker 600-6 may be positioned by penetrating the shaft 300-6. The locker 600-6 may be located inside a shaft 300-6. The locker 600-6 may be exposed to the outside of the shaft 300-6 at an end portion of the shaft 300-6 facing the knob assembly N-6.

One end of the locker 600-6 may be exposed to the outside of the shaft 300-6, and the other end of the locker 600-6 may be exposed to the outside of the shaft 300-6 and the case 100.

The locker 600-6 may include a flange between the case 100 and the shaft 300-6. The flange may prevent the locker 600-6 from being separated to the outside of the case 100. The flange may prevent the movement of the locker 600-6 relative to the shaft 300-6.

A shaft elastic member 301-6 may be positioned between the flange and the inside of the shaft 300-6.

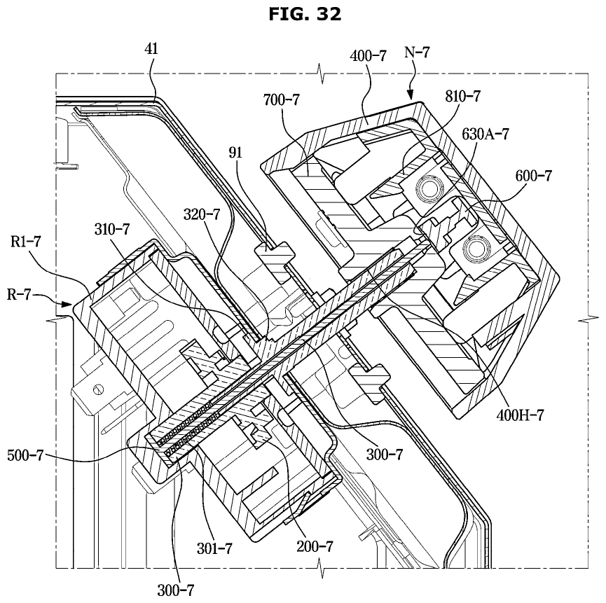

FIG. 32 is a cross-sectional view of a knob assembly N-7 and a configuration related thereto according to one embodiment of the present disclosure.

A locker 600-7 according to one embodiment of the present disclosure will be described with reference to FIG. 32.

The locker 600-7 may extend along a direction in which a shaft 300-7 extends.

The locker 600-7 may be positioned by penetrating the shaft 300-7. The locker 600-7 may be located inside the shaft 300-7. The locker 600-7 may be exposed to the outside of the shaft 300-7 at an end portion of the shaft 300-7 facing the knob assembly N-7.

One end of the locker 600-7 may be exposed to the outside of the shaft 300-7, and the other end of the locker 600-7 may be located between the shaft 300-7 and the case 100.

A flange may be defined at the other end of the locker 600-7.

A shaft elastic member 301-7 may be positioned between the flange and the inside of the shaft 300-7.

The flange may prevent the movement of the locker 600-7 relative to the shaft 300-7.

Unless the context clearly indicates otherwise, the embodiments described above may be combined with other embodiments. Alternatively, it should be understood that combinations between embodiments are possible unless an embodiment is clearly limited in combination with another embodiment. Any combination of one embodiment with another embodiment are considered to be disclosed in the present disclosure.

While the present disclosure has been particularly described with reference to exemplary embodiments, it should be understood by those of skilled in the art that various changes in form and details may be made without departing from the spirit and scope of the present disclosure.

1. A cooking apparatus comprising:
a heating source;
a housing comprising a control panel;
a regulator body configured to operate the heating source and be disposed adjacent to the control panel;
a shaft to be coupled to the regulator body and while the shaft is coupled to the regulator body, the shaft being moveable between a first shaft position, in which a rotation of the shaft with respect to the regulator body is restricted, and a second shaft position, in which the rotation of the shaft with respect to the regulator body for operating the heating source is unrestricted;
a knob to be coupled to the shaft so as to move along with the shaft while the knob is coupled to the shaft; and
a locking device including a locker moveable relative to the knob, whereby locker is configured to move between a locking position, in which the locker is positioned between the knob and the control panel to restrict a movement of the knob while the shaft is at the first shaft position, and an unlocking position, in which the locker is at least partially received in a locker receiving space to allow the movement of the knob.

2. The cooking apparatus of claim 1, further comprising:
a button configured to move between a first button position that restricts a movement of the locker from the locking position to the unlocking position and a second button position that allows the movement of the locker from the locking position to the unlocking position,
wherein the locker receiving space is disposed on the button.

3. The cooking apparatus of claim 2, wherein
the locker extends along a direction facing the control panel.

4. The cooking apparatus of claim 2, wherein
the button comprises a locker contact surface adjacent to an opening of the locker receiving space,
wherein the locker is disposed at the locking position in which the locker comes into contact with the locker contact surface while the button is at the first button position, and the locker is movable to the unlocking position in which the locker is received in the locker receiving space while the button is at the second button position.

5. The cooking apparatus of claim 3, further comprising:
a button holder received in the knob and comprising a locking device mounting space,
wherein the button is received in the locking device mounting space, the button is disposed adjacent to one surface of the button holder while the button is at the first button position, and the button moves closer to another surface facing the one surface of the button holder while the button moves from the first button position to the second button position.

6. The cooking apparatus of claim 5, wherein
the button holder comprises a guide hook portion disposed adjacent to the button and protruding toward the control panel to guide a movement of the button.

7. The cooking apparatus of claim 5, further comprising:
a button elastic member disposed between the knob and the button holder to allow the button to be pressed from the second button position to the first button position.

8. The cooking apparatus of claim 7, wherein
the button elastic member comprises: a first button elastic member; and a second button elastic member different from the first button elastic member to allow the button to move linearly.

9. The cooking apparatus of claim 8, wherein
the regulator body further comprises a case comprising a stopper groove,
wherein the shaft comprises:
a shaft body at least partially inserted into the case; and
a stopper protruding from the shaft body to be received in the stopper groove while the shaft is at the first shaft position, the stopper detached from the stopper groove while the shaft is at the second shaft position.

10. The cooking apparatus of claim 1, wherein
a distance by which the locker moves from the locking position to the unlocking position is greater than or equal to a distance by which the shaft moves from the first shaft position to the second shaft position.

11. The cooking apparatus of claim 2, wherein
a direction, along which the button moves from the first button position to the second button position, intersects a direction, along which the locker moves from the locking position to the unlocking position.

12. The cooking apparatus of claim 11, further comprising:
a locker supporter mounted on the control panel and provided to come into contact with the locker to prevent the control panel from being scratched by the locker.

13. The cooking apparatus of claim 12, wherein
the locker is disposed adjacent to the shaft to prevent vibration of the knob.

14. The cooking apparatus of claim 12, further comprising:
a weight disposed on an opening of the knob, the weight comprising a locker hole through which the locker penetrates to allow the locker to be exposed to an outside of the weight.

15. The cooking apparatus of claim 14, wherein
the weight comprises a button movement limiter protruding to an opposite direction facing the control panel to be in contact with the button based on the button being at the second button position, so as to guide movement of the button to the second button position.
